(19) United States
(12) Patent Application Publication
(10) Pub. No.: US 2016/0139283 A1
(43) Pub. Date: May 19, 2016

(54) SEISMIC WAVEFIELD DEGHOSTING AND NOISE ATTENUATION

(71) Applicant: WESTERNGECO L.L.C., Houston, TX (US)

(72) Inventors: Yousif Izzeldin Kamil, Gatwick (GB); Nizare El Yadari, Gatwick (GB); Massimiliano Vassallo, Brighton (GB)

(21) Appl. No.: 14/900,441

(22) PCT Filed: Jun. 19, 2014
(86) PCT No.: PCT/US2014/043073

§ 371 Date: Dec. 21, 2015

Related U.S. Application Data
(60) Provisional application No. 61/839,281, filed on Jun. 25, 2013.
(60) Provisional application No. 61/973,709, filed on Apr. 1, 2014.

(51) Int. Cl. G01V 1/36; G01V 1/28

(52) U.S. Cl. CPC G01V 1/364; G01V 1/282; G01V 2210/56

(57) ABSTRACT

A method can include receiving measured values that include representations of constructive interference and destructive interference from an upgoing wavefield and a downgoing ghost wavefield reflected from a sea surface; and estimating at least one of the wavefields with attenuated noise.

### RELATED APPLICATIONS

This application claims priority to and the benefit of U.S. Provisional Patent Application having Ser. No. 61/839,281, filed on 25 Jun. 2013, and U.S. Provisional Patent Application having Ser. No. 61/973,709, filed on 1 Apr. 2014, both of which are incorporated by reference herein.

### BACKGROUND

Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Various techniques described herein pertain to processing of data such as, for example, seismic data.

### SUMMARY

In accordance with some embodiments, a method is performed that includes: receiving measured values that include representations of constructive interference and destructive interference from an upgoing wavefield and a downgoing ghost wavefield reflected from a sea surface; and estimating at least one of the wavefields with attenuated noise.

In accordance with some embodiments, a method is performed that includes: receiving measured values that include representations of constructive interference and destructive interference from an upgoing wavefield and a downgoing ghost wavefield reflected from a sea surface; and via joint statistics of at least a portion of the measured values and one of the wavefields, estimating the one of the wavefields with attenuated noise.

In accordance with some embodiments, a system is provided that includes a processor; memory accessible by the processor; one or more modules stored in the memory and that include processor-executable instructions to instruct the system to: receive measured values that include representations of constructive interference and destructive interference from an upgoing wavefield and a downgoing ghost wavefield reflected from a sea surface; and estimate at least one of the wavefields with attenuated noise.

In accordance with some embodiments, a system is provided that includes a processor; memory accessible by the processor; one or more modules stored in the memory and that include processor-executable instructions to instruct the system to: receive measured values that include representations of constructive interference and destructive interference from an upgoing wavefield and a downgoing ghost wavefield reflected from a sea surface; and via joint statistics of at least a portion of the measured values and one of the wavefields, estimate the one of the wavefields with attenuated noise.

In some embodiments, an aspect includes assuming noise and signals represented by measured values to be jointly Gaussian.

In some embodiments, an aspect includes joint statistics that include covariance of at least a portion of measured values and correlation between at least a portion of the measured values and one of the wavefields.

In some embodiments, an aspect includes ghost model independent estimating of one of the wavefields with attenuated noise.

In some embodiments, an aspect includes ghost model dependent estimating of at least one of the wavefields with attenuated noise.

In some embodiments, an aspect includes combining wavefields estimated via ghost model independent estimating and via ghost model dependent estimating.

In some embodiments, an aspect includes determining statistics of measurement noise and applying the statistics to attenuate noise.

In some embodiments, an aspect includes generating a ghost model.

In some embodiments, an aspect includes implementing a ghost model, which may be a generated ghost model.

In some embodiments, an aspect includes pressure values, particle velocity values or pressure values and particle velocity values.

In some embodiments, an aspect includes estimating one of the wavefields as a deghosted and noise attenuated wavefield.

In some embodiments, an aspect includes measured values that include seismic data acquired via a seismic survey.

In accordance with some embodiments, one or more computer-readable storage media include computer-executable instructions to instruct a system to: receive single measurement data; and minimize error in an upgoing wavefield at least in part via a ghost operator where the minimization of error attenuates noise leakage in at least a portion of the single measurement data.

In some embodiments, an aspect includes instructions to instruct a system to estimate the ghost operator.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a technique;

FIG. 2 illustrates examples of multiple reflections and examples of techniques;

FIG. 3 illustrates an example of a survey technique;

FIG. 4 illustrates an example of a system;

FIG. 5 illustrates an example of a survey technique;

FIG. 6 illustrates an example of a scenario and a method;

FIG. 7 illustrates an example of a method;

FIG. 8 illustrates an example of a method;

FIG. 9 illustrates an example of a method; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less that 1 Hz and/or optionally more than 100 Hz). Seismic data may be processed and interpreted, for example, to understand better composition, fluid content, extent and geometry of subsurface rocks.

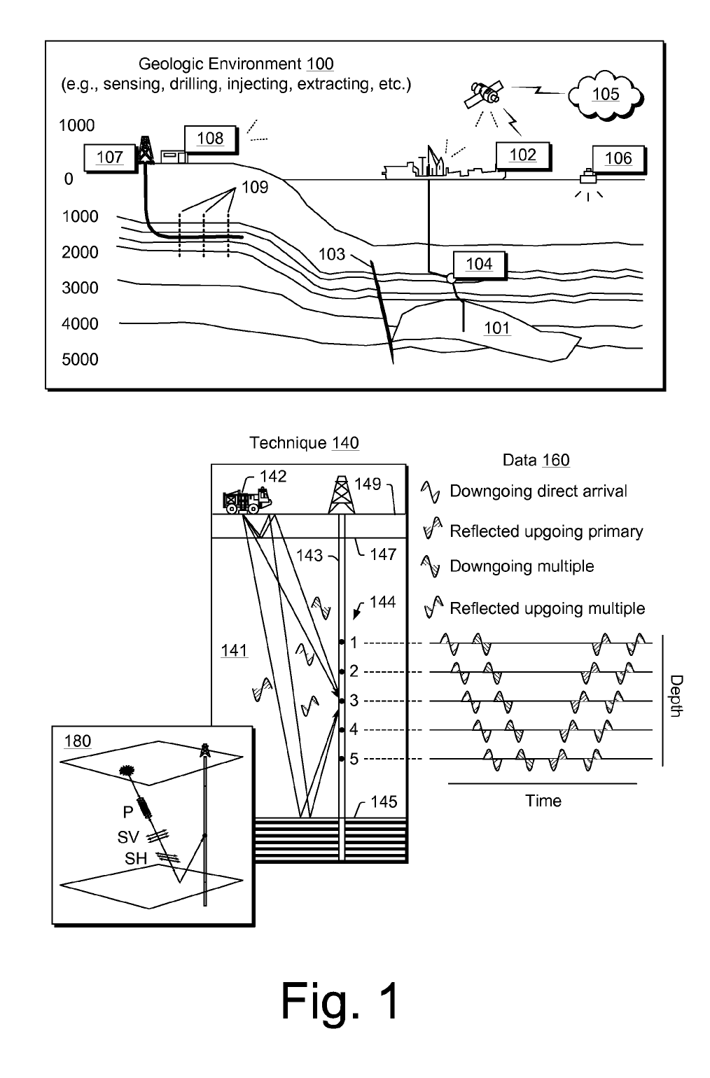

FIG. 1 shows an example of a geologic environment 100 (e.g., an environment that includes a sedimentary basin, a reservoir 101, a fault 103, one or more fractures 109, etc.) and an example of an acquisition technique 140 to acquire seismic data (see, e.g., data 160). As an example, a system may process data acquired by the technique 140, for example, to allow for direct or indirect management of sensing, drilling, injecting, extracting, etc., with respect to the geologic environment 100. In turn, further information about the geologic environment 100 may become available as feedback (e.g., optionally as input to the system). As an example, an operation may pertain to a reservoir that exists in the geologic environment 100 such as, for example, the reservoir 101. As an example, a technique may provide information (e.g., as an output) that may specify one or more location coordinates of a feature in a geologic environment, one or more characteristics of a feature in a geologic environment, etc.

As an example, the geologic environment 100 may be referred to as a formation or may include one or more formations. As an example, a formation may be a unit of lithostratigraphy, for example, a body of rock that is sufficiently distinctive and continuous that it can be mapped. As an example, in stratigraphy, a formation may be a body of strata of predominantly one type or combination of types where, for example, multiple formations form groups, and subdivisions of formations are members.

As an example, a sedimentary basin may be a depression in the crust of the Earth, for example, formed by plate tectonic activity in which sediments accumulate. Over a period of geologic time, continued deposition may cause further depression or subsidence. With respect to a petroleum systems analysis, if rich hydrocarbon source rocks occur in combination with appropriate depth and duration of burial, hydrocarbon generation may possibly occur within a basin. Exploration plays and prospects may be developed in basins or regions in which a complete petroleum system has some likelihood of existing. The geologic environment 100 of FIG. 1 may include one or more plays, prospects, etc.

As an example, a system may be implemented to process seismic data, optionally in combination with other data. Processing of data may include generating one or more seismic attributes, rendering information to a display or displays, etc. A process or workflow may include interpretation, which may be performed by an operator that examines renderings of information and that identifies structure or other features within such renderings. Interpretation may be or include analyses of data with a goal to generate one or more models and/or predictions (e.g., about properties and/or structures of a subsurface region).

As an example, a system may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. For example, a commercially available framework environment marketed as the OCEAN® framework environment (Schlumberger Limited, Houston, Tex.) allows for integration of add-ons (and/or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components (e.g., modules, blocks, etc.) may be implemented as add-ons (and/or plug-ins) that conform to and operate according to specifications of a framework environment. As an example, a framework environment may include one or more application programming interfaces (APIs) that specify calls (e.g., API calls) and responses to such calls (e.g., results of calculations, renderings of information, retrieval of data, etc.). As an example, a method may include making one or more API calls to a framework, a component of a framework, etc.

As an example, seismic data may be processed using a framework such as the OMEGA® framework (Schlumberger Limited, Houston, Tex.). The OMEGA® framework provides features that can be implemented for processing of seismic data, for example, through prestack seismic interpretation (PSI) and seismic inversion. A framework may be scalable such that it enables processing and imaging on a single workstation, on a massive compute cluster, etc. As an example, one or more techniques, technologies, etc. described herein may optionally be implemented in conjunction with a framework such as, for example, the OMEGA® framework.

A framework for processing data may include features for 2D line and 3D seismic surveys. Modules for processing seismic data may include features for prestack seismic interpretation (PSI), optionally pluggable into a framework such as the OCEAN® framework. A workflow may be specified to include processing via one or more frameworks, plug-ins, add-ons, etc. A workflow may include quantitative interpretation, which may include performing pre- and poststack seismic data conditioning, inversion (e.g., seismic to properties and properties to synthetic seismic), wedge modeling for thin-bed analysis, amplitude versus offset (AVO) and amplitude versus angle (AVA) analysis, reconnaissance, etc. As an example, a workflow may aim to output rock properties based at least in part on processing of seismic data. As an example, various types of data may be processed to provide one or more models (e.g., earth models). For example, consider processing of one or more of seismic data, well data, electromagnetic and magnetic telluric data, reservoir data, etc.

In the example of FIG. 1, the geologic environment 100 includes an offshore portion and an on-shore portion. As an example, a geologic environment may be or include one or more of an offshore geologic environment, a seabed geologic environment, an ocean bed geologic environment, etc.

As an example, the geologic environment 100 may be outfitted with any of a variety of sensors, detectors, actuators, etc. For example, equipment 102 may include communication circuitry to receive and to transmit information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 105 that may be configured for communications, noting that the satellite may additionally or alternatively include circuitry for imagery (e.g., spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 107 and/or 108 may include components, a system, systems, etc. for fracturing, seismic sensing, analysis of seismic data, assessment of one or more fractures, etc.

As an example, a system may be used to perform one or more workflows. A workflow may be a process that includes a number of worksteps. A workstep may operate on data, for example, to create new data, to update existing data, to receive data, etc. As an example, a system may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., executable code, etc.). As an example, a workflow may include rendering information to a display (e.g., a display device). As an example, a workflow may include receiving instructions to interact with rendered information, for example, to process information and optionally render processed information. As an example, a workflow may include transmitting information that may control, adjust, initiate, etc. one or more operations of equipment associated with a geologic environment (e.g., in the environment, above the environment, etc.).

In FIG. 1, the technique 140 may be implemented with respect to a geologic environment 141. As shown, an energy source (e.g., a transmitter) 142 may emit energy where the energy travels as waves that interact with the geologic environment 141. As an example, the geologic environment 141 may include a bore 143 where one or more sensors (e.g., receivers) 144 may be positioned in the bore 143. As an example, energy emitted by the energy source 142 may interact with a layer (e.g., a structure, an interface, etc.) 145 in the geologic environment 141 such that a portion of the energy is reflected, which may then be sensed by one or more of the sensors 144. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 141 is shown as including a layer 147 that resides below a surface layer 149. Given such an environment and arrangement of the source 142 and the one or more sensors 144, energy may be sensed as being associated with particular types of waves.

As an example, a “multiple” may refer to multiply reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 1, the acquired data 160 can include data associated with downgoing direct arrival waves, reflected upgoing primary waves, downgoing multiple reflected waves and reflected upgoing multiple reflected waves. The acquired data 160 is also shown along a time axis and a depth axis. As indicated, in a manner dependent at least in part on characteristics of media in the geologic environment 141, waves travel at velocities over distances such that relationships may exist between time and space. Thus, time information, as associated with sensed energy, may allow for understanding spatial relations of layers, interfaces, structures, etc. in a geologic environment.

FIG. 1 also shows various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources. As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by cross-plotting P-wave and S-wave velocities, and/or by other techniques.

As an example of parameters that may characterize anisotropy of media (e.g., seismic anisotropy), consider the Thomsen parameters ε, δ and γ. The Thomsen parameter δ describes depth mismatch between logs (e.g., actual depth) and seismic depth. As to the Thomsen parameter ε, it describes a difference between vertical and horizontal compressional waves (e.g., P or P-wave or quasi compressional wave qP or qP-wave). As to the Thomsen parameter γ, it describes a difference between horizontally polarized and vertically polarized shear waves (e.g., horizontal shear wave SH or SH-wave and vertical shear wave SV or SV-wave or quasi vertical shear wave qSV or qSV-wave). Thus, the Thomsen parameters ε and γ may be estimated from wave data while estimation of the Thomsen parameter δ may involve access to additional information.

As an example, seismic data may be acquired for a region in the form of traces. In the example of FIG. 1, the technique 140 may include the source 142 for emitting energy where portions of such energy (e.g., directly and/or reflected) may be received via the one or more sensors 144. As an example, energy received may be discretized by an analog-to-digital converter that operates at a sampling rate. For example, acquisition equipment may convert energy signals sensed by a sensor to digital samples at a rate of one sample per approximately 4 ms. Given a speed of sound in a medium or media, a sample rate may be converted to an approximate distance. For example, the speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

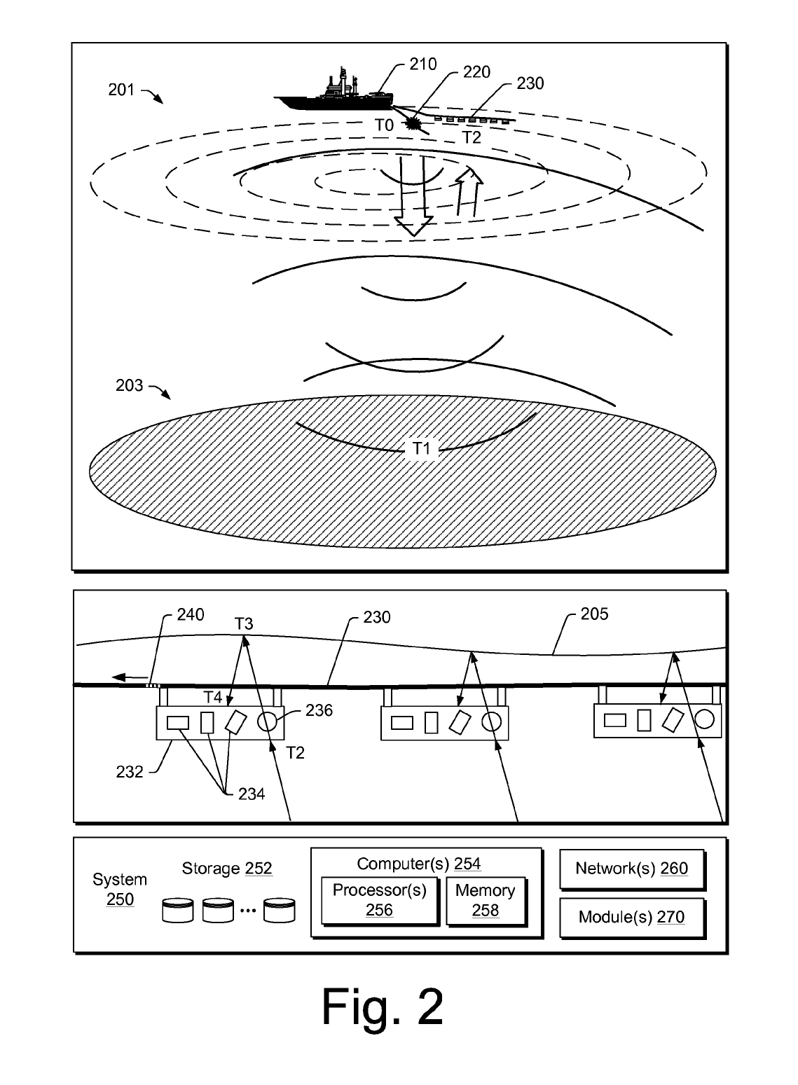

FIG. 2 shows an example of a geologic environment 201 that includes a seabed 203 and a sea surface 205. As shown, equipment 210 such as a ship may tow an energy source 220 and a string of sensors 230 at a depth below the sea surface 205. In such an example, the energy source 220 may emit energy at a time T0, a portion of that energy may be reflected from the seabed 203 at a time T1 and a portion of that reflected energy may be received at the string of sensors 230 at a time T2.

As mentioned with respect to the technique 140 of FIG. 1, a wave may be a primary or a wave may be a multiple. As shown in an enlarged view of the geologic environment 201, the sea surface 205 may act to reflect waves such that sensors 232 of the string of sensors 230 may sense multiples as well as primaries. In particular, the sensors 232 may sense so-called sea surface multiples, which may be multiples from primaries or multiples of multiples (e.g., due to sub-seabed reflections, etc.).

As an example, each of the sensors 232 may sense energy of an upgoing wave at a time T2 where the upgoing wave reflects off the sea surface 205 at a time T3 and where the sensors may sense energy of a downgoing multiple reflected wave at a time T4 (see also the data 160 of FIG. 1 and data 240 of FIG. 2). In such an example, sensing of the downgoing multiple reflected wave may be considered noise that interferes with sensing of one or more upgoing waves. As an example, an approach that includes summing data acquired by a geophone and data acquired by a hydrophone may help to diminish noise associated with downgoing multiple reflected waves. Such an approach may be employed, for example, where sensors may be located proximate to a surface such as the sea surface 205 (e.g., arrival times T2 and T4 may be relatively close). As an example, the sea surface 205 or a water surface may be an interface between two media. For example, consider an air and water interface. As an example, due to differing media properties, sound waves may travel at about 1,500 m/s in water and at about 340 m/s in air. As an example, at an air and water interface, energy may be transmitted and reflected (e.g., consider an “impedance” mismatch).

As an example, each of the sensors 232 may include at least one geophone 234 and a hydrophone 236. As an example, a geophone may be a sensor configured for seismic acquisition, whether onshore and/or offshore, that can detect velocity produced by seismic waves and that can, for example, transform motion into electrical impulses. As an example, a geophone may be configured to detect motion in a single direction. As an example, a geophone may be configured to detect motion in a vertical direction. As an example, three mutually orthogonal geophones may be used in combination to collect so-called 3C seismic data. As an example, a hydrophone may be a sensor configured for use in detecting seismic energy in the form of pressure changes under water during marine seismic acquisition. As an example, hydrophones may be positioned along a string or strings to form a streamer or streamers that may be towed by a seismic vessel (e.g., or deployed in a bore). Thus, in the example of FIG. 2, the at least one geophone 234 can provide for motion detection and the hydrophone 236 can provide for pressure detection. As an example, the data 240 (e.g., analog and/or digital) may be transmitted via equipment, for example, for processing, etc.

As an example, a method may include analysis of hydrophone response and vertical geophone response, which may help to improve a PZ summation, for example, by reducing receiver ghost and/or free surface-multiple noise contamination (see, e.g., PZSUM algorithm, discussed further below). As an example, a ghost may be defined as a reflection of a wavefield as reflected from a water surface (e.g., water and air interface) that is located above a receiver, a source, etc. (e.g., a receiver ghost, a source ghost, etc.). As an example, a receiver may experience a delay between an upgoing wavefield and its downgoing ghost, which may depend on depth of the receiver.

As an example, a surface marine cable may be or include a buoyant assembly of electrical wires that connect sensors and that can relay seismic data to the recording seismic vessel. As an example, a multi-streamer vessel may tow more than one streamer cable to increase the amount of data acquired in one pass. As an example, a marine seismic vessel may be about 75 m long and travel about 5 knots, for example, while towing arrays of air guns and streamers containing sensors, which may be located, for example, about a few meters below the surface of the water. A so-called tail buoy may assist crew in location an end of a streamer. As an example, an air gun may be activated periodically, such as about every 25 m (e.g., about every 10 seconds) where the resulting sound wave travels into the Earth, which may be reflected back by one or more rock layers to sensors on a streamer, which may then be relayed as signals (e.g., data, information, etc.) to equipment on the tow vessel.

In the example of FIG. 2, the equipment 210 may include a system such as the system 250. As shown in FIG. 2, the system 250 includes one or more information storage devices 252, one or more computers 254, one or more network interfaces 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc.

As an example, pressure data may be represented as “P” and velocity data may be represented as “Z”; noting, however, that the vertical component of a measured particle velocity vector may be denoted “V” and that “Z” may refer to a scaled, measured particle velocity. For example, in various equations presented herein, “V” represents a measured velocity and “Z” represents a scaling thereof.

As an example, a hydrophone may sense pressure information (e.g., P data) and a geophone may sense velocity information (e.g., V and/or Z data). As an example, a hydrophone may output signals, optionally as digital data, for example, for receipt by a system. As an example, a geophone may output signals, optionally as digital data, for example, for receipt by a system. As an example, the system 250 may receive P and V/Z data via one or more of the one or more network interfaces 260 and process such data, for example, via execution of instructions stored in the memory 258 by the processor 256. As an example, the system 250 may store raw and/or processed data in one or more of the one or more information storage devices 252.

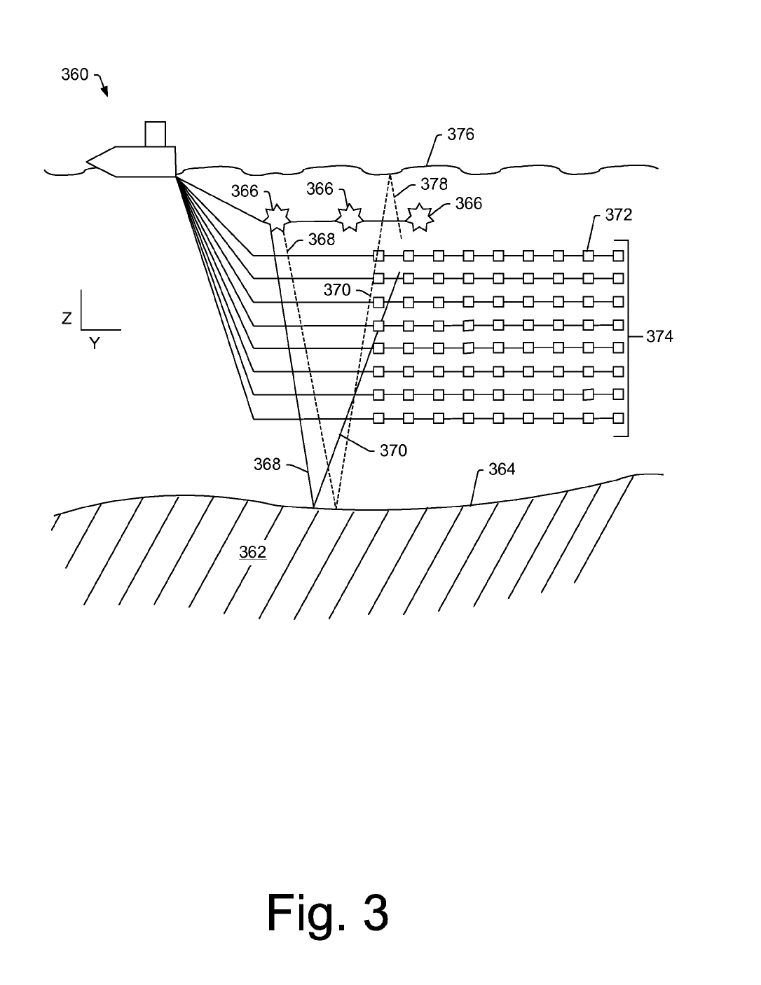

FIG. 3 shows an example of a side view of a marine-based survey 360 of a subterranean subsurface 362. The subsurface 362 includes a seafloor surface 364. Seismic sources 366 may include marine sources such as vibroseis or air guns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., about 5 Hz) and increase the seismic wave to a higher frequency (e.g., about 80 Hz to about 90Hz or more) over time.

The component(s) of the seismic waves 368 may be reflected and converted by the seafloor surface 364 (e.g., as a reflector), and seismic wave reflections 370 may be received by a plurality of seismic receivers 372. As an example, seismic waves may penetrate the subsurface 362 below the seafloor surface 364 and be reflected by one or more reflectors therein and received by one or more of the plurality of seismic receivers 372. As shown in the example of FIG. 3, the seismic receivers 372 may be disposed on a plurality of streamers (e.g., a streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like. One or more streamer steering devices may be used to control streamer position.

In one implementation, the seismic wave reflections 370 may travel upward and reach the water/air interface at the water surface 376, a portion of reflections 370 may then reflect downward again (e.g., sea-surface ghost waves 378) and be received by the plurality of seismic receivers 372. As an example, the sea-surface ghost waves 378 may be referred to as surface multiples. In such an example, the point on the water surface 376 at which the wave is reflected downward may be referred to as a downward reflection point.

Electrical signals generated by one or more of the receivers 372 may be transmitted to a vessel 380 via transmission cables, wireless communication or the like. The vessel 380 may then transmit the electrical signals to a data processing center. Alternatively, the vessel 380 may include an onboard computing system capable of processing the electrical signals (e.g., representing seismic data). As an example, surveys may be of formations deep beneath the surface. The formations may include multiple reflectors, some of which may include dipping events, and may generate multiple reflections (including wave conversion) for receipt by the seismic receivers 372. As an example, seismic data may be processed to generate a seismic image of the subsurface.

As an example, a marine seismic acquisition system may tow streamers in the streamer array 374 at an approximate even depth (e.g., about 5 m to about 10 m). However, the marine based survey 360 may tow each streamer in streamer array 374 at different depths such that seismic data may be acquired and processed in a manner that avoids the effects of destructive interference due to sea-surface ghost waves. For instance, the marine-based survey 360 of FIG. 3 illustrates eight streamers towed by the vessel 380 at eight different depths. The depth of each streamer may be controlled and maintained using the birds disposed on each streamer.

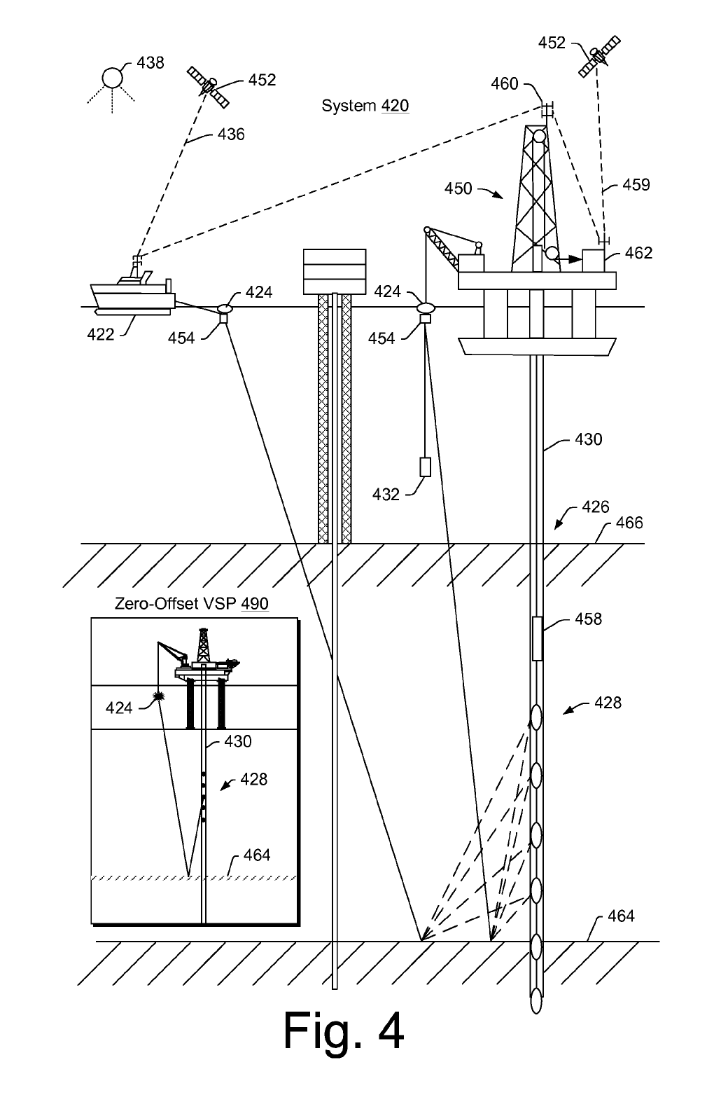

FIG. 4 shows an example of a system 420 in which one or more vessels 422 may be employed to enable seismic profiling, e.g., three-dimensional vertical seismic profiling (VSP) or rig/offset vertical seismic profiling (VSP). In the example of FIG. 4, the system 420 is illustrated as including a rig 450, the vessel 422, and one or more acoustic receivers 428 (e.g., a receiver array). As an example, a vessel may include a source 424 (e.g., or source array) and/or the rig 450 may include a source 424 (e.g., or source array).

As an example, the vessel 422 may travel a path or paths where locations may be recorded through the use of navigation system signals 436. As an example, such signals may be associated with a satellite-based system that includes one or more satellites 452 and 438. As an example, the satellite 438 may be part of a global positioning system (GPS), which may be implemented to record position, speed, direction, and other parameters of the vessel 422. As an example, one or more satellites, communication equipment, etc. may be configured to provide for VSAT communications, VHF communications, UHF communications, etc.

In the example of FIG. 4, the acoustic receivers 428 may be part of a data acquisition system 426, for example, that may be deployed in borehole 430 via one or more of a variety of delivery systems, such as wireline delivery systems, slickline delivery systems, and other suitable delivery systems. As an example, the acoustic receivers 428 may be communicatively coupled with processing equipment 458, which may be positioned at a downhole location. By way of example, processing equipment 458 may include a telemetry system for transmitting data from acoustic receivers 428 to additional processing equipment 462 located at the surface, e.g., on the rig 450 and/or vessels 422. As an example, information acquired may optionally be transmitted (see, e.g., signals 459).

Depending on the specifics of a given data communication system, examples of surface processing equipment 462 may include a radio repeater 460 and/or one or more of a variety of other and/or additional signal transfer components and signal processing components. The radio repeater 460 along with other components of processing equipment 462 may be used to communicate signals, e.g., UHF and/or VHF signals, between vessels (e.g., the vessel 422 and one or more other vessels) and the rig 450, for example, to enable further communication with downhole data acquisition system 426.

As an example, the acoustic receivers 428 may be coupled to the surface processing equipment 462 via one or more wire connections; noting that additionally or alternatively wireless and/or optical connections may be employed.

As an example, the surface processing equipment 462 may include a synchronization unit, for example, to assist with coordination of emissions from one or more sources (e.g., optionally dithered (delayed) source arrays). As an example, coordination may extend to one or more receivers (e.g., consider the acoustic receivers 428 located in borehole 430). As an example, a synchronization unit may use coordinated universal time, optionally employed in cooperation with a global positioning system (e.g., to obtain UTC data from GPS receivers of a GPS system).

FIG. 4 illustrates examples of equipment for performing seismic profiling that can employ simultaneous or near-simultaneous acquisition of seismic data. By way of example, the seismic profiling may include three-dimensional vertical seismic profiling (VSP) but other applications may utilize rig/offset vertical seismic profiling or seismic profiling employing walkaway lines. As an example, an offset source may be provided by the source 424 located on the rig 450, on the vessel 422, and/or on another vessel or structure (e.g., stationary and/or movable from one location to another location).

As an example, a system may employ one or more of various arrangements of a source or sources on a vessel(s) and/or a rig(s). As shown in the example of FIG. 4, the acoustic receivers 428 of downhole acquisition system 426 are configured to receive the source signals, at least some of which are reflected off a reflection boundary 464 located beneath a sea bottom 436. The acoustic receivers 428 may generate data streams that are relayed uphole to a suitable processing system, e.g., the processing system 462.

While the acoustic receivers 428 may generate data streams, a navigation system may determine a real-time speed, position, and direction of the vessel 422 and also estimate initial shot times accomplished via signal generators 454 of the appropriate source 424 (e.g., or source array). A source controller may be part of the surface processing equipment 462 (e.g., located on the rig 450, on the vessel 422, or at other suitable location) and may be configured with circuitry that can control firing of acoustic source generated signals so that the timing of an additional shot time (e.g., optionally a shot time via a slave vessel) may be based on an initial shot time (e.g., a shot time via a master vessel) plus a dither value.

As an example, a synchronization unit of, for example, the surface processing equipment 462, may coordinate firing of dithered acoustic signals with recording of acoustic signals by the downhole acquisition system 426. A processor system may be configured to separate a data stream of the initial shot and a data stream of the additional shot via a coherency filter. As an example, an approach may employ simultaneous acquisition and/or may not perform separation of the data streams. In such cases, the dither may be effectively zero.

After an initial shot time at T=0 (T0) is determined, subsequent firings of acoustic source arrays may be offset by a dither. The dithers may be positive or negative and sometimes created as pre-defined random delays. Use of dithers facilitates the separation of simultaneous or near-simultaneous data sets to simplify the data processing. The ability to have acoustic source arrays fire in simultaneous or near-simultaneous patterns reduces the overall amount of time used for three-dimensional vertical seismic profiling source acquisition. This, in turn, may reduce rig time. As a result, the overall cost of the seismic operation may be reduced, rendering the data intensive process much more accessible.

If acoustic source arrays used in the seismic data acquisition are widely separated, the difference in move-outs across the acoustic receiver array of the wave fields generated by the acoustic sources can be sufficient to obtain a relatively clean data image via processing the data. However, even when acoustic sources are substantially co-located in time, data acquired a method involving dithering of the firing times of the individual sources may be processed to a formation image. For example, consider taking advantage of the incoherence of the data generated by one acoustic source when seen in the reference time of another acoustic source.

Also shown in FIG. 4 is an inset example of a zero-offset vertical seismic profile (VSP) scenario 490. In such an example, an acquisition geometry may be limited to an ability to position equipment that is physically coupled to the rig 450. As shown, for given the acquisition geometry, there may be no substantial offset between the source 424 and bore 430 (e.g., consider a depth that may be greater than the aspect ratio of the illustration of FIG. 4). In such an example, a zero-offset VSP may be acquired where seismic waves travel substantially vertically down to a reflector (e.g., the layer 464) and up to the receiver 428, which may be a receiver array. Where one or more vessels are employed (e.g., the vessel 422), one or more other types of surveys may be performed. As an example, a three-dimensional VSP may be performed using a vessel.

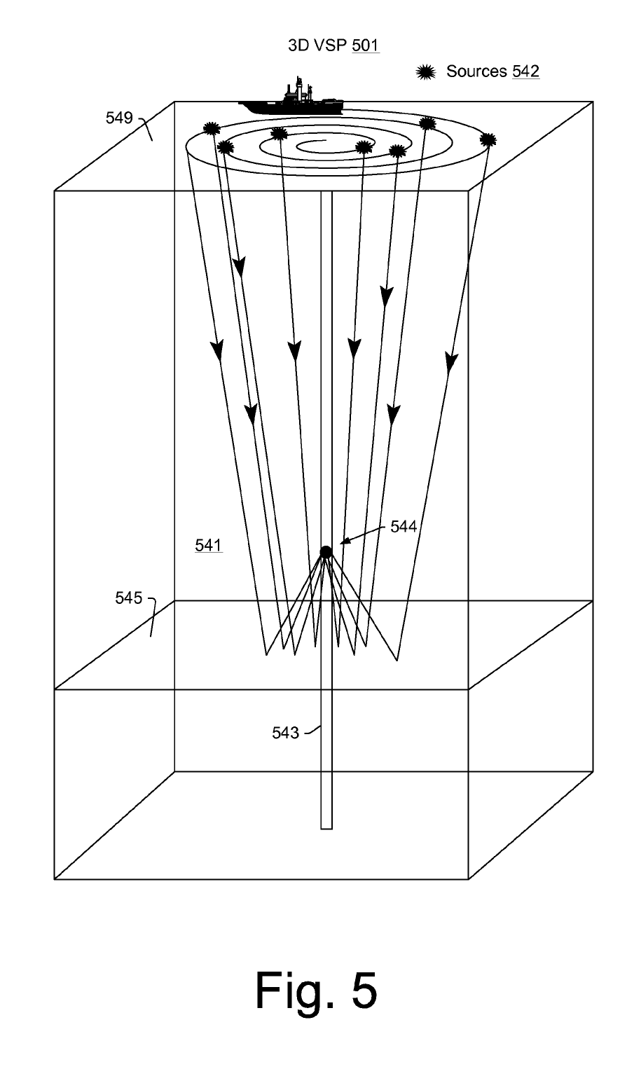

FIG. 5 shows an example of a technique 501 with respect to a geologic environment 541, a surface 549, at least one energy source (e.g., a transmitter) 542 that may emit energy where the energy travels as waves that interact with the geologic environment 541. As an example, the geologic environment 541 may include a bore 543 where one or more sensors (e.g., receivers) 544 may be positioned in the bore 543. As an example, energy emitted by the energy source 542 may interact with a layer (e.g., a structure, an interface, etc.) 545 in the geologic environment 441 such that a portion of the energy is reflected, which may then be sensed by at least one of the one or more of the sensors 544.

As an example, a 3D VSP technique may be implemented with respect to an onshore and/or an offshore environment. As an example, an acquisition technique for an onshore (e.g., land-based) survey may include positioning a source or sources along a line or lines of a grid; whereas, in an offshore implementation, source positions may be laid out in lines or in a spiral centered near a well.

A 3D acquisition technique may help to illuminate one or more 3D structures (e.g., one or more features in a geologic environment). Information acquired from a 3D VSP may assist with exploration and development, pre-job modeling and planning, etc. As an example, a 3D VSP may fill in one or more regions that lack surface seismic survey information, for example, due to interfering surface infrastructure or difficult subsurface conditions, such as, for example, shallow gas, which may disrupt propagation of P-waves (e.g., seismic energy traveling through fluid may exhibit signal characteristics that differ from those of seismic energy traveling through rock).

As an example, a VSP may find use to tie time-based surface seismic images to one or more depth-based well logs. For example, in an exploration area, a nearest well may be quite distant such that a VSP is not available for calibration before drilling begins on a new well. Without accurate time-depth correlation, depth estimates derived from surface seismic images may include some uncertainties, which may, for example, add risk and cost (e.g., as to contingency planning for drilling programs). As an example, a so-called intermediate VSP may be performed, for example, to help develop a time-depth correlation. For example, an intermediate VSP may include running a wireline VSP before reaching a total depth. Such a survey may, for example, provide for a relatively reliable time-depth conversion; however, it may also add cost and inefficiency to a drilling operation and, for example, it may come too late to forecast drilling trouble. As an example, a seismic while drilling process may be implemented, for example, to help reduce uncertainty in time-depth correlation without having to stop a drilling process. Such an approach may provide real-time seismic waveforms that can allow an operator to look ahead of a drill bit, for example, to help guide a drill string to a target total depth.

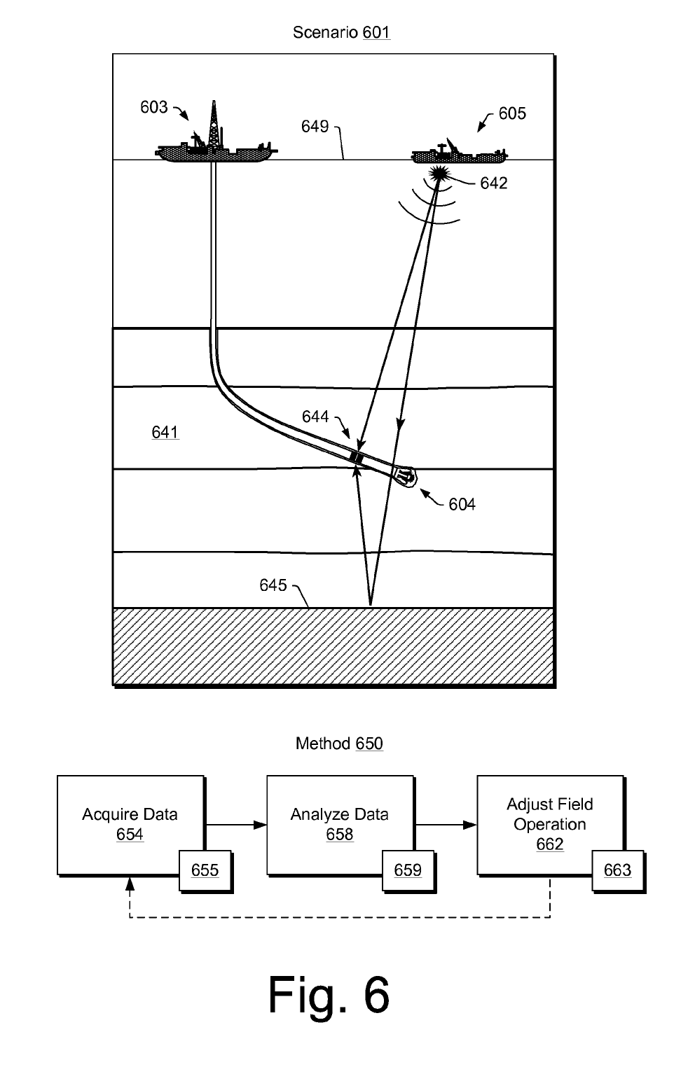

FIG. 6 shows an example scenario 601 where drilling equipment 603 operates a drill bit 604 operatively coupled to an equipment string that includes one or more sensors (e.g., one or more receivers) 644. In the scenario 601, the drill bit 604 is advanced in a geologic environment 641 that includes stratified layers disposed below a sea bed surface where the layers include a layer 645. As shown in the example of FIG. 6, at a water surface 649 of the geologic environment 641, seismic equipment 605 includes a seismic energy source 642 that can emit seismic energy into the geologic environment 641.

As an example, the seismic equipment 605 may be movable, duplicated, etc., for example, to emit seismic energy from various positions, which may be positions about a region of the geologic environment 641 that includes the drill bit 604. As an example, the scenario 601 may be a VSP scenario, for example, where the equipment 603, 644, 605 and 642 can perform a seismic survey (e.g., a VSP while drilling survey).

As an example, a survey may take place during one or more so-called “quiet” periods during which drilling is paused. As an example, data acquired via a survey may be analyzed where results from an analysis or analyses may be used, at least in part, to direct further drilling, make assessments as to a drilled portion of a geologic environment, etc. As an example, a method may optionally include processing in near real-time, which may, for example, be instructive for seismic while drilling, etc.

In FIG. 6, the method 650 includes an acquisition block 654 for acquiring data, an analysis block 658 for analyzing at least a portion of the data and an adjustment block 662 for adjusting one or more field operations, for example, based at least in part on an output from analyzing data.

The method 650 may be associated with various computer-readable media (CRM) blocks or modules 653, 657 and 663. Such blocks or modules may include instructions suitable for execution by one or more processors (or processor cores) to instruct a computing device or system to perform one or more actions. As an example, a single medium may be configured with instructions to allow for, at least in part, performance of various actions of the method 650. As an example, a computer-readable medium (CRM) may be a computer-readable storage medium (e.g., a non-transitory medium).

As noted above, in marine seismic acquisitions, sensors may record desired upgoing wavefield energy reflected from one or more geological formations and reflections from the sea surface, which may be referred to as downgoing wavefield energy (e.g., or seismic ghosts).

As an example, a ghost may cause one or more notches in a frequency spectrum, for example, at one or more frequencies that may be described as a function of receiver depth below a water/air interface and angle of incidence of a wavefield at a receiver. In practice, receiver depths may be chosen so that these frequency notches are beyond the range of frequencies desired for the seismic data. Depths of less than about 10 meters may be used, making the first occurrence of a notch in the spectrum of the pressure wavefield above about 75 Hz in a standard scenario. However, deploying seismic streamers deeper than about 10 m may allow for recording more energy at low frequency. Yet, such an approach may produce ghost notches at lower frequencies than about 75 Hz. In the foregoing example, 75 Hz is provided as an example frequency for purposes of explaining various types of phenomena.

Assuming that a direct arrival has been removed from measured data (e.g., a source may also be shot at a depth greater than the measuring cable depth), measured pressure data may be written as a combination of upgoing and downgoing wavefields as well as measured noise:

Pₙ=U+D+nₚ. (1)

In the foregoing expression, equation (1), U represents the upgoing wavefield; D represents the downgoing wavefield; and nₚ represents the pressure noise. In such an example, the combination U+D can result in constructive interference and destructive interference in different frequencies along a signal spectrum. For example, such interference(s) can create nulls or notches in a recorded spectrum, which may reduce the effective bandwidth of the recorded seismic wavefield.

In the frequency domain, D can be written as a function of U by using the wavefield extrapolation operator Ψ and the reflection coefficient ε at the water-air interface as follows:

D(f)=εΨU(f)=Εe^{-j2πfτ}U(f). (2)

In the foregoing equation, j is the imaginary unit, f represents frequency and T is the time delay that the upgoing wave will take to travel to the sea surface and reflect back to the recording seismic array. For a flat sea surface, the reflection coefficient can be approximated as ε≈−1. Note that in the special case of vertical incidence angle, the delay

$$τ = \frac{2 z}{c}$$

where z is the cable depth and c is the acoustic speed of seismic wave in water. Also, the same expression can be written in the frequency wavenumber (FK) domain as:

D(f, k)=εe^{-j2zk}^{_{z}}U(f, k), (3)

where k_{z} represents the vertical wavenumber and given by:

$${k}_{z} = \frac{2 π f}{c} cos θ = \sqrt{{( \frac{2 π f}{c} )}^{2} - {k}_{x}^{2} - {k}_{y}^{2}} , \qquad ( 4 )$$

where θ is the incidence angle of the wavefield at the receiver and where kₓ and k_{y} denote the inline and cross line wavenumbers, respectively. By substituting the expression for D given by equation (2) or (3) into equation (1), one may obtain the following expression for the total pressure:

Pₙ=(1+εe^{-j2zk}^{_{z}})U+nₚ=GₚU+nₚ. (5)

where Gₚ may be referred to as the pressure ghost operator. Per equation (5), ghost notches are a function of frequency, depth of streamer and incidence angle.

In a deghosting problem, a solution may aim to provide an estimate of U. An algorithm that may aim to fill ghost notches, may attempt to restore signal bandwidth and, as a result, increase resolution of a final seismic image. An algorithm may, for example, rely on additional measurements either by using dual streamers or by additionally making use of the particle motion related measurements when these measurements are available at the same cable. Particle motion measurements can describe a particle displacement vector itself, or alternatively and equivalently a particle velocity vector or a particle acceleration vector, depending on the measuring devices, and or any subset of the components of these vectors. In some embodiments, a method may include applying one or more methods and techniques to multi-measurement deghosting.

As an example, a method may include characterizing a vertical particle motion wavefield and/or may include analyzing one or more other acquisition scenarios (e.g., over-under pressure measurements, multi-sensor measurements including horizontal particle motion components, ocean bottom cables and nodes, slanted and/or curved streamers, whether curved and/or slanted for the length of the streamer, or with different slants and/or curves over multiple sections of the streamer, and others).

In an example embodiment, a method may include scaling the vertical component V_{z}_{ₙ} of the particle velocity vector with the obliquity factor (e.g., k_{z}) as:

$${Z}_{n} = \frac{ρ 2 π f}{{k}_{z}} {V}_{{z}_{n}} , \qquad ( 6 )$$

where ρ represents the density of the medium. By analogy with equation (1), the scaled measured vertical particle velocity Zₙ can be expressed as:

$$\begin{matrix}{Z}_{n} = U - D + {n}_{z} \\ = ( 1 - {ɛe}^{- j 2 {zk}_{z}} ) U + {n}_{z} \\ = {G}_{z} U + {n}_{z} ,\end{matrix} \qquad ( 7 )$$

In the foregoing equation, G_{z} is the vertical motion ghost operator and n_{z} is the scaled measured noise. Note that the ghost operators affecting the pressure and the vertical velocity have different signs. This is because the downgoing vertical velocity wavefield reverses its direction.

Depending on whether the ghost models for the pressure and velocity (i.e., Gₚ and G_{z}) are assumed to be known or not, deghosting algorithms can be broadly classified as model-dependent or model-independent, respectively.

### Optimal De-Ghosting Algorithm (ODG)

One deghosting algorithm that has been previously proposed is referred to as the Optimal De-Ghosting algorithm (ODG). For example, consider equations (5) and (7) as written below in compact form:

$$\underbrace{[ \begin{matrix}{P}_{n} \\ {Z}_{n}\end{matrix} ]} = \underbrace{[ \begin{matrix}{G}_{p} \\ {G}_{z}\end{matrix} ]} U + \underbrace{[ \begin{matrix}{n}_{p} \\ {n}_{z}\end{matrix} ]} . \qquad ( 8 )$$

The ODG utilizes a ghost model in addition to noise statistics as estimated from pressure and vertical particle velocity measurements to minimize the leakage of noise on final deghosted data. In ODG, this is achieved by formulating the deghosting as a weighted least squares minimization problem. The solution is given as:

Û_{ODG}=(H^{H}Rₙₙ⁻¹H)⁻¹H^{H}Rₙₙ⁻¹y. (9)

where, Rₙₙ is the 2nd order statistics of the noise vector n. (·)^{H} stands for conjugate transpose. In the special case of uncorrelated Nₚ and N_{z}, the ODG solution can be given by:

$${\hat{U}}_{ODG} = \frac{\frac{{G}_{p}^{H}}{{σ}_{{n}_{p}^{2}}} {P}_{n } + \frac{{G}_{Z}^{H}}{{σ}_{{n}_{z}^{2}}} {Z}_{n}}{\frac{{\vert {G}_{p} \vert}^{2}}{{σ}_{{n}_{p}^{2}}} + \frac{{\vert {G}_{z} \vert}^{2}}{{σ}_{{n}_{z}^{2}}}} . \qquad ( 10 )$$

When both the ghost model and second order statistics of the noise are sufficiently accurate, the ODG solution minimizes the deghosting noise. However, being a model-dependent algorithm (MDA), ODG is sensitive to the ghost model that is implemented and thus, any perturbations in the estimated cable depth can result in suboptimal performance (i.e., suboptimal results).

### PZ Sum Algorithm

The PZ Sum algorithm (PZSUM) is a model-independent algorithm (MIA) or model-independent deghosting method that estimates an upgoing wavefield as an average of noisy Pₙ and Zₙ measurements:

$${\hat{U}}_{PZSUM} = \frac{{P}_{n} + {Z}_{n}}{2} . \qquad ( 11 )$$

In one hand, PZSUM may provide a benefit in that it uses a small subset of propagation parameters (e.g., the density of the medium and the acoustic speed of sound in water to compute the obliquity factor given in equation (6)). Also, PZSUM is not sensitive to a ghost model. On the other hand, however, a drawback of PZSUM is that it ignores noise statistics on pressure and particle motion measurements, which can be unfavorable, particularly at the lower end of the frequency spectrum where the particle velocity measurements are often noisy.

In some embodiments, a Bayesian statistical deghosting estimator may be utilized that works on pressure and particle velocity measurements, and that relates an upgoing wave to P and V (e.g., or Z). In such an example, an estimator can utilize correlations between P and V measurements to optimally estimate their sum. In various embodiments, a method is implemented as a model-independent approach (e.g., MIA) to deghost data and separate upgoing and downgoing wavefields while attenuating the noise leaking on the deghosted data. In some embodiments, a method is extended to a case of seismic data of a similar nature (e.g., pressure data), which may be measured at different depths.

In some embodiments, an upgoing wavefield U is estimated to be optimal (or improved) vis-a-vis output signal to noise ratio by using the total pressure and particle motion measurements. In such an example, noise statistics for pressure and vertical velocity may be assumed to be known or estimated from the data and the problem may be formulated in the frequency space domain. However, it is noted that such an approach may be implemented in one or more other domains such as, for example, a time-space domain, a time-wavenumber domain, a frequency-wavenumber domain, etc.

Various examples are described herein, some with respect to particular equations, variables, etc. As an example, an approach may include making an assumption that pressure and three components of particle velocity measurements are zero mean. Given such an assumption, in an example embodiment, a Bayesian estimation scheme may be formulated where it may be possible to obtain a linear minimum mean square error estimator (I.m.m.s.e. estimator) for an upgoing wavefield, for example, as a weighted sum of pressure and particle velocity components. While an I.m.m.s.e. estimator is mentioned, one or more other types of cost functions may be formulated such as, for example, a cost function based at least in part on an L1 norm metric.

Below, as an example, a theoretical framework is described using various equations that include Pₙ and Zₙ to represent pressure and particle velocity. Such a framework may be extended (e.g., formulations thereof) to include inline and crossline velocities (e.g., even in the case of a flat recording surface).

As an example, Pₙ and Zₙ may be present as part of an optimal PZSUM method where, for example, a formulation may be:

$$[ \begin{matrix}{P}_{n} \\ {Z}_{n}\end{matrix} ] = \underbrace{[ \begin{matrix}1 & 1 \\ 1 & - 1\end{matrix} ]} [ \begin{matrix}U \\ D\end{matrix} ] + [ \begin{matrix}{n}_{p} \\ {n}_{z}\end{matrix} ] . \qquad ( 12 )$$

In such an example, estimation of an upgoing wavefield and a downgoing wave can be generalized as follows:

$$[ \begin{matrix}\hat{U} \\ \hat{D}\end{matrix} ] = \underline{\underline{W}} [ \begin{matrix}{P}_{n} \\ {Z}_{n}\end{matrix} ] , \qquad ( 13 )$$

where W is the weight matrix and the special case of PZSUM, which may be written as:

$${\underline{\underline{W}}}_{PZ sum} = {\underline{\underline{A}}}^{- 1} = 0.5 [ \begin{matrix}1 & 1 \\ 1 & - 1\end{matrix} ] . \qquad ( 14 )$$

However, as mentioned, in this example, it is possible to seek the optimum (or improved) weight matrix in the minimum (or reduced) mean square error sense.

Without loss of generality, below, various aspects are explained as to an example derivation of an upgoing wavefield; noting that appropriate derivations may be followed to obtain a downgoing wavefield (e.g., via appropriate modifications, substitutions, etc.).

As an example, the upgoing wavefield can be estimated as:

Û=wₚ^{H}Pₙ+w_{z}^{H}Zₙ, (15)

where wₚ and w_{z} correspond to the weights leading to optimal deghosted data. Denoting the vectors of weights and measurements by w and M, equation (15) can be compactly written as follows:

$$\begin{matrix}\hat{U} = {\underline{w}}^{H} [ \begin{matrix}{P}_{n} \\ {Z}_{n}\end{matrix} ] \\ = {\underline{w}}^{H} \underline{M} .\end{matrix} \qquad ( 16 )$$

Given the forgoing compact form, a problem can be formulated to minimize (or reduce) the following cost:

$$\begin{matrix}w = arg {min}_{\underline{w}} E \{ {\vert \hat{U} - U \vert}^{2} \} \\ = arg {min}_{\underline{w}} E \{ {\vert {\underline{w}}^{H} \underline{M} - U \vert}^{2} \} ,\end{matrix} \qquad ( 17 )$$

where E{·} is the expectation operator taken over the pressure, velocity measurements and noise distributions. In this example, the minimizer of the cost function is the linear minimum mean square error estimator (I.m.m.s.e. estimator), which is a function of the second order statistics of the unknown upgoing wave; noting, as mentioned, that one or more other types of cost functions may be formulated (e.g., L1 norm, etc.). In the absence of noise, the ideal upgoing wave U can be obtained precisely by averaging noise-free P and Z. Also, note that the relationship between recorded and modeled noise-free multi-measurements may be given as follows:

Pₙ=P+nₚ.

Zₙ=Z+n_{z} (18)

In terms of P and Z, the cost function in equation (17) can be written as:

$$\begin{matrix}\underline{w} = arg {min}_{\underline{w}} E \{ {\vert {\underline{w}}^{H} \underline{M} - \frac{P + Z}{2} \vert}^{2} \} \\ = arg {min}_{\underline{w}} E \{ {\vert {\underline{w}}^{H} \underline{M} - 0.5 {\underline{1}}^{T} [ \begin{matrix}P \\ Z\end{matrix} ] \vert}^{2} \} ,\end{matrix} \qquad ( 19 )$$

where the minimizer can be expressed as the solution of the following set of normal equations:

R_{MM}w=r_{MU}, (20)

where R_{MM} is defined as the measurement covariance matrix and r_{MU} is defined as correlation vector between the measurements and the desired upgoing wavefield. Mathematically, they may be defined as follows:

$${R}_{MM} = [ \begin{matrix}{R}_{{P}_{n} {P}_{n}} & {R}_{{P}_{n} {Z}_{n}} \\ {R}_{{Z}_{n} {P}_{n}} & {R}_{{Z}_{n} {Z}_{n}}\end{matrix} ] \\ {\underline{r}}_{MU} = 0.5 [ \begin{matrix}{R}_{{P}_{n} P} + {R}_{{P}_{n} Z} \\ {R}_{{Z}_{n} P} + {R}_{{Z}_{n} Z}\end{matrix} ] , \qquad ( 21 )$$

where R_{xy} is the correlation between X and Y. In this example, note that the covariance matrix in (20) can be estimated from measured data. For example, a covariance matrix may be estimated directly from measured data.

As an example, it is possible to define the noise covariance matrix Rₙₙ as:

$${R}_{nn} = [ \begin{matrix}{σ}_{{n}_{P}}^{2} & {σ}_{{n}_{P} {n}_{Z}} \\ {σ}_{{n}_{Z} {n}_{P}} & {σ}_{{n}_{Z}}^{2}\end{matrix} ] , \qquad ( 22 )$$

which may be estimated from the measurement data, for example, using one or more of various signal processing theories and/or techniques.

Where an assumption may be made that noise is uncorrelated with signal, r_{MU} may be rewritten as:

$${\underline{r}}_{MU} = 0.5 ( [ \begin{matrix}{R}_{{P}_{n} {P}_{n}} + {R}_{{P}_{n} {Z}_{n}} \\ {R}_{{Z}_{n} {P}_{n}} + {R}_{{Z}_{n} {Z}_{n}}\end{matrix} ] - [ \begin{matrix}{σ}_{{n}_{P}}^{2} + {σ}_{{n}_{P} {n}_{Z}} \\ {σ}_{{n}_{Z} {n}_{P}} + {σ}_{{n}_{Z}}^{2}\end{matrix} ] ) . \qquad ( 23 )$$

Further, the vector r_{MU} can be compactly written as a function of R_{MM} and Rₙₙ as follows:

$${\underline{r}}_{MU} = 0.5 ( ( {R}_{MM} - {R}_{nn} ) [ \begin{matrix}1 \\ 1\end{matrix} ] ) . \qquad ( 24 )$$

Referring to equation (23), it shows that the vector r_{MU} may be obtained from multi-sensor data in combination with noise statistics. Consequently, from equation (20), an optimal (or improved) upgoing wavefield may be estimated from measured data, for example, directly without explicit knowledge of a ghost operator. For example, consider estimation of an optimal (or improved) upgoing wavefield via the following equation:

$$\hat{U} = {\underline{r}}_{MU}^{H} {R}_{MM}^{- 1} [ \begin{matrix}{P}_{n} \\ {Z}_{n}\end{matrix} ] . \qquad ( 25 )$$

Equation (25) provides a general formula of the I.m.m.s.e. for the upgoing wavefield by using the noise statistics to attenuate the noise leaking into the combination of Pₙ and Zₙ.

As an example, the resulting minimum (or reduced) mean square error may be given as:

C=R_{UU}−r_{MU}^{H}R_{MM}⁻¹r_{MU}, (26)

where by analogy with RMM, R_{UU} is the upgoing signal power and can be estimated from:

$${R}_{UU} = \frac{\begin{matrix}{R}_{{P}_{n} {P}_{n}} + {R}_{{P}_{n} {Z}_{n}} + {R}_{{Z}_{n} {P}_{n}} + {R}_{{Z}_{n} {Z}_{n}} - \\ ( {σ}_{{n}_{P}}^{2} + {σ}_{{n}_{P} {n}_{Z}} + {σ}_{{n}_{Z} {n}_{P}} + {σ}_{{n}_{Z}}^{2} )\end{matrix}}{4} . \qquad ( 27 )$$

As an example, substituting equations (21) and (24) into equation (25) can lead to the optimal estimate of the upgoing wavefield as follows:

$$\hat{U} = \frac{1}{2} ( 1 - \frac{{R}_{{Z}_{n} {Z}_{n}} {σ}_{{n}_{P}}^{2} - {R}_{{Z}_{n} {P}_{n}} {σ}_{{n}_{Z}}^{2}}{{R}_{{P}_{n} {P}_{n}} {R}_{{Z}_{n} {Z}_{n}} - {R}_{{P}_{n} {Z}_{n}} {R}_{{Z}_{n} {P}_{n}}} ) {P}_{n} + \frac{1}{2} ( 1 - \frac{{R}_{{P}_{n} {P}_{n}} {σ}_{{n}_{Z}}^{2} - {R}_{{P}_{n} {Z}_{n}} {σ}_{{n}_{P}}^{2}}{{R}_{{P}_{n} {P}_{n}} {R}_{{Z}_{n} {Z}_{n}} - {R}_{{P}_{n} {Z}_{n}} {R}_{{Z}_{n} {P}_{n}}} ) {Z}_{n} \qquad ( 28 )$$

Such a solution may be written as a function of the PZSUM estimate in equation (11) as:

$$\hat{U} = {\hat{U}}_{PZSUM} - \frac{1}{2} ( \frac{( {R}_{{Z}_{n} {Z}_{n}} {σ}_{{n}_{P}}^{2} - {R}_{{Z}_{n} {P}_{n}} {σ}_{{n}_{Z}}^{2} ) {P}_{n} + ( {R}_{{P}_{n} {P}_{n}} {σ}_{{n}_{Z}}^{2} - {R}_{{P}_{n} {Z}_{n}} {σ}_{{n}_{P}}^{2} ) {Z}_{n}}{{R}_{{P}_{n} {P}_{n}} {R}_{{Z}_{n} {Z}_{n}} - {R}_{{P}_{n} {Z}_{n}} {R}_{{Z}_{n} {P}_{n}}} ) . \qquad ( 29 )$$

From equation (29), it may be noted that: 1) if the data is noise free, the solution becomes the PZSUM solution; and 2) the correlation between the pressure and the vertical particle velocity component implicitly provides valuable information about the ghost operator. To demonstrate this from equations (5) and (7), one may consider:

R_{P}_{ₙ}_{Z}_{ₙ}=E{PₙZₙ^{H}}GₚG_{Z}^{H}R_{UU}=R_{Z}_{ₙ}_{P}_{ₙ}^{H}, (30)

where R_{UU} is the upgoing signal power. Similarly:

R_{P}_{ₙ}_{P}_{ₙ}=G_{P}G_{P}^{H}R_{UU}+σₙ_{ₚ}².

R_{Z}_{ₙ}_{Z}_{ₙ}=G_{Z}G_{Z}^{H}R_{UU}+σₙ_{_{Z}}² (31)

In the case of a known ghost operator (i.e., model-dependent deghosting or a MDA), the upgoing wavefield can be estimated by substituting (30) and (31) into (28) as follows:

$$\hat{U} = \frac{\frac{{G}_{P}^{H}}{{σ}_{{n}_{P}}^{2}} {P}_{n} + \frac{{G}_{Z}^{H}}{{σ}_{{n}_{Z}}^{2}} {Z}_{n}}{\frac{{\vert {G}_{p} \vert}^{2}}{{σ}_{{n}_{p}}^{2}} + \frac{{\vert {G}_{z} \vert}^{2}}{{σ}_{{n}_{z}}^{2}} + \frac{1}{{R}_{UU}}} . \qquad ( 32 )$$

In a case where the vertical particle velocity measurement is noisier than the pressure (i.e., σₙ_{_{Z}}² goes to infinity), the upgoing wavefield in equation (29) may be given by:

$$\hat{U} = \frac{1}{2} \frac{{R}_{{P}_{n} {P}_{n}} - {σ}_{{n}_{P}}^{2} + {R}_{{Z}_{n} {P}_{n}}}{{R}_{{P}_{n} {P}_{n}}} {P}_{n} . \qquad ( 33 )$$

Substituting equations (30) and (31) into (33) gives the following:

$$\begin{matrix}\hat{U} = \frac{1}{2} \frac{{G}_{P} {G}_{P}^{H} {R}_{UU } + {G}_{P} {G}_{Z}^{H} {R}_{UU}}{{G}_{P} {G}_{P}^{H} {R}_{UU} + {σ}_{{n}_{P}}^{2}} {P}_{n} \\ = \frac{{G}_{P}^{H}}{{G}_{P} {G}_{P}^{H} + \frac{{σ}_{{n}_{P}}^{2}}{{R}_{UU}}} {P}_{n} .\end{matrix} \qquad ( 34 )$$

Note that equation (34) is a generalization of a single sensor deghosting method handling noise.

As an example, it is possible to extend the solution in equation (25) to include inline and crossline velocity measurements (e.g., optionally even in the case of a flat acquisition system). In this extended multi-measurement formulation, the upgoing wavefield can be provided as a weighted sum of the measurement vector M as follows:

$$\begin{matrix}\hat{U} = {\underline{w}}^{H} \underline{M} \\ = {\underline{r}}_{MU}^{H} {R}_{MM}^{- 1} \underline{M} \\ = {\underline{r}}_{MU}^{H} {R}_{MM}^{- 1} [ \begin{matrix}{P}_{n} \\ {X}_{n} \\ {Y}_{n} \\ {Z}_{n}\end{matrix} ] .\end{matrix} \qquad ( 35 )$$

By analogy with equation (6), Xₙ, Yₙ are the scaled noisy inline and crossline particle velocity measurements. In equation (35), R_{MM} and r_{MU} are redefined as:

$${R}_{MM} = [ \begin{matrix}{R}_{{P}_{n} {P}_{n}} & {R}_{{P}_{n} {X}_{n}} & {R}_{{P}_{n} {Y}_{n}} & {R}_{{P}_{n} {Z}_{n}} \\ {R}_{{X}_{n} {P}_{n}} & {R}_{{X}_{n} {X}_{n}} & {R}_{{X}_{n} {Y}_{n}} & {R}_{{X}_{n} {Z}_{n}} \\ {R}_{{Y}_{n} {P}_{n}} & {R}_{{Y}_{n} {X}_{n}} & {R}_{{Y}_{n} {Y}_{n}} & {R}_{{Y}_{n} {Z}_{n}} \\ {R}_{{Z}_{n} {P}_{n}} & {R}_{{Z}_{n} x} & {R}_{{Z}_{n} {Y}_{n}} & {R}_{{Z}_{n} {Z}_{n}}\end{matrix} ] \\ \begin{matrix}{\underline{r}}_{MU} = 0.5 [ \begin{matrix}{R}_{{P}_{n} P} + {R}_{{P}_{n} Z} \\ {R}_{{X}_{n} P} + {R}_{{X}_{n} Z} \\ {R}_{{Y}_{n} P} + {R}_{{Y}_{n} Z} \\ {R}_{{Z}_{n } P} + {R}_{{Z}_{n} Z}\end{matrix} ] \\ = 0.5 ( ( {R}_{MM} - {R}_{nn} ) [ \begin{matrix}1 \\ 0 \\ 0 \\ 1\end{matrix} ] ) ,\end{matrix} \qquad ( 36 )$$

and Rₙₙ is defined as:

$${R}_{nn} = [ \begin{matrix}{σ}_{{n}_{P}}^{2} & {σ}_{{n}_{P} {n}_{x}} & {σ}_{{n}_{P} {n}_{Y}} & {σ}_{{n}_{P} {n}_{Z}} \\ {σ}_{{n}_{X} {n}_{P}} & {σ}_{{n}_{X}}^{2} & {σ}_{{n}_{X} {n}_{Y}} & {σ}_{{n}_{X} {n}_{Z}} \\ {σ}_{{n}_{Y} {n}_{P}} & {σ}_{{n}_{Y} {n}_{X}} & {σ}_{{n}_{Y}}^{2} & {σ}_{{n}_{Y} {n}_{Z}} \\ {σ}_{{n}_{Z} {n}_{P}} & {σ}_{{n}_{Z} {n}_{X}} & {σ}_{{n}_{Z} {n}_{Y}} & {σ}_{{n}_{Z}}^{2}\end{matrix} ] . \qquad ( 37 )$$

Note that the developed solution for the deghosting problem may be extended to various types of acquisition surface (e.g., slanted and/or curved streamers, whether curved and/or slanted for the length of the streamer, or with different slants and/or curves over multiple sections of the streamer).

Equations (25) and (35) represent certain aspects of the model-independent deghosting approach (e.g., MIA) in accordance with some embodiments disclosed herein. In these example equations, a linear estimator that was obtained in a minimum mean square error sense is applied. This estimator is the optimal linear filter in the sense that no further linear transformation of the measurement can extract additional information about the upgoing wave in order to further reduce the error. On the other hand, if the noise and signals can be assumed to be jointly Gaussian, this estimator may be considered to be the optimal estimator for the problem and may be considered to be suitable among linear and nonlinear filters in the minimum mean square error sense.

As an example, a method may include receiving measured pressure values and measured particle velocity values that include representations of constructive interference and destructive interference from an upgoing wavefield and a downgoing ghost wavefield reflected from a sea surface; and, for at least a portion of the measured pressure values and at least a portion of the measured particle velocity values, estimating one or more pressure values and one or more particle velocity values for the upgoing wavefield based at least in part on a covariance matrix (see, e.g., equation (21)) and a noise covariance matrix (see, e.g., equation (22)) that depend on the measured pressure values and measured particle velocity values. In such an example, an assumption may be made that measured pressure and particle velocity values are correlated and that noise is uncorrelated thereto.

As an example, a method may include performing an optimization, such as minimizing a function. For example, consider minimizing a cost function (see, e.g., equation (19); solution to equation (25)) to estimate pressure values and particle velocity values for an upgoing wavefield (see, e.g., equation (25) and (28) or (29)), for example, as reflected from a sea bed.

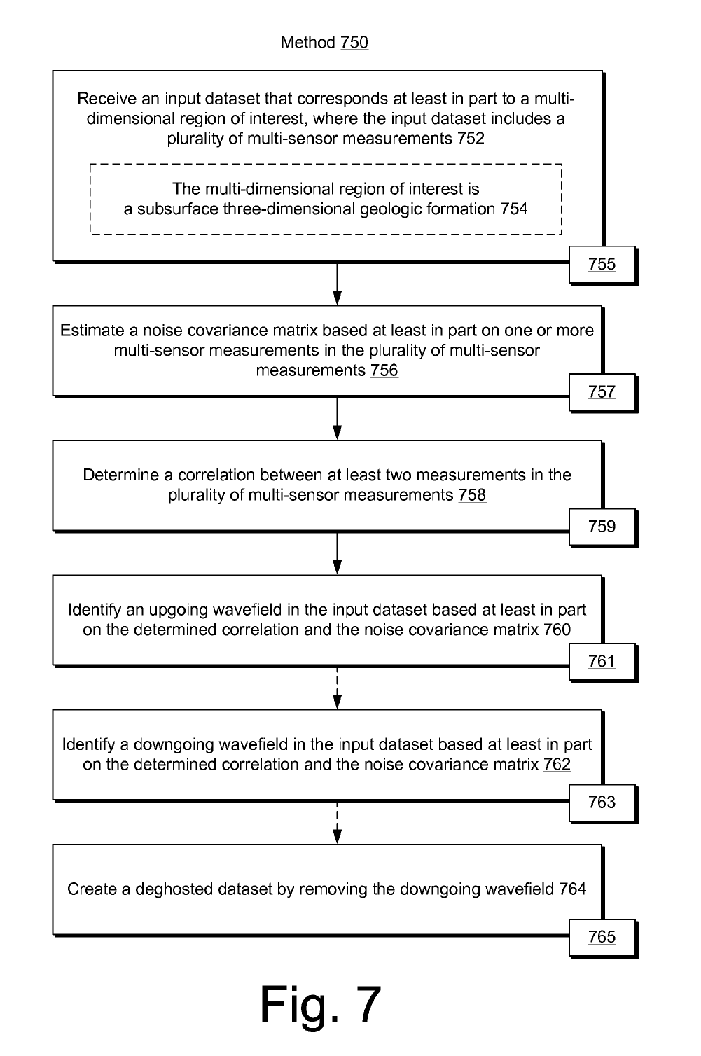

FIG. 7 shows an example of a method 750, which may be a workflow, part of a workflow, etc. As an example, the method 750 may be performed on a computing system (see, e.g., the system 250 of FIG. 2). As an example, the method 750, or a portion thereof, may be applied to deghosting an input dataset that corresponds to a multi-dimensional region of interest. As an example, the method 750 may be used in conjunction with one or more other techniques for processing collected data, modeling, etc.

As shown in FIG. 7, the method 750 includes a reception block 752 for receiving an input dataset corresponding to a multi-dimensional region of interest, where, for example, the input dataset may include a plurality of multi-sensor measurements (e.g., consider a plurality of P and V measurements). In some embodiments, the multi-dimensional region of interest can be that of a subsurface three-dimensional geologic formation. In the method 750, for example, a region block 754 may be included for specifying a region, which may be that of a subsurface three-dimensional geologic formation having at least one associated dataset, etc. As an example, a method may include accessing a dataset set via a network (e.g., or networks). In such an example, a method may receive a dataset as a portion of a larger dataset or, for example, receive an entire dataset.

As shown in FIG. 7, the method 750 includes an estimation block 756 for estimating a noise covariance matrix based at least in part on one or more multi-sensor measurements in the plurality of multi-sensor measurements. Per a determination block 758, the method 750 includes determining a correlation between at least two measurements in the plurality of multi-sensor measurements. As also shown in the example of FIG. 7, the method 750 includes an identification block 760 for identifying an upgoing wavefield in the input dataset based at least in part on the determined correlation and the noise covariance matrix. As an example, consider a Bayesian statistical deghosting estimator that may work on pressure and particle velocity measurements and that can relate an upgoing wave to P and V and that can utilize determined correlations between P and V measurements to optimally estimate their sum. Thus, as an example, the method 750 may implement a technique that solves a problem formulated as a Bayesian estimation scheme where a linear minimum mean square error estimator (I.m.m.s.e.) may be obtained for an upgoing wavefield as a weighted sum of pressure and particle velocity components. Such a technique may be referred to as a Bayesian seismic wavefield separation technique.

As indicated in FIG. 7, as an example, the method 750 may include an identification block 762 for identifying a downgoing wavefield in the input dataset based at least in part on the determined correlation and the noise covariance matrix. In such an example, the method 750 may include identifying at least one upgoing wavefield and at least one downgoing wavefield, for example, where wavefield separation may refer to “separating” out one or more wavefields represented by data in a dataset (e.g., or datasets).

As an example, the method 750 may include a creation block 764 for a deghosted dataset by removing the downgoing wavefield. For example, a method may include identifying a downgoing wavefield followed by deghosting based at least in part on the identified downgoing wavefield. As an example, information pertaining to one or more wavefields may be identified followed by deghosting based at least in part on at least one of the one or more identified wavefields.

In an example embodiment, the method 750 include a display block for displaying on a computing system one or more of the input dataset, the upgoing wavefield, the downgoing wavefield, and the deghosted dataset. For example, a computing system may include circuitry that can render information for display via a display, a projector, etc. For example, a computing system may include one or more graphics processors (e.g., GPUs, etc.). A computing system may include a wired and/or a wireless interface for transmission of information to a device such as, for example, a display, a projector, etc.

In an example embodiment, the method 750 include a display block for displaying on a computing system one or more of the input dataset, the upgoing wavefield, the downgoing wavefield, and the deghosted dataset. For example, a computing system may include circuitry that can render information for display via a display, a projector, etc. For example, a computing system may include one or more graphics processors (e.g., GPUs, etc.). A computing system may include a wired and/or a wireless interface for transmission of information to a device such as, for example, a display, a projector, etc.

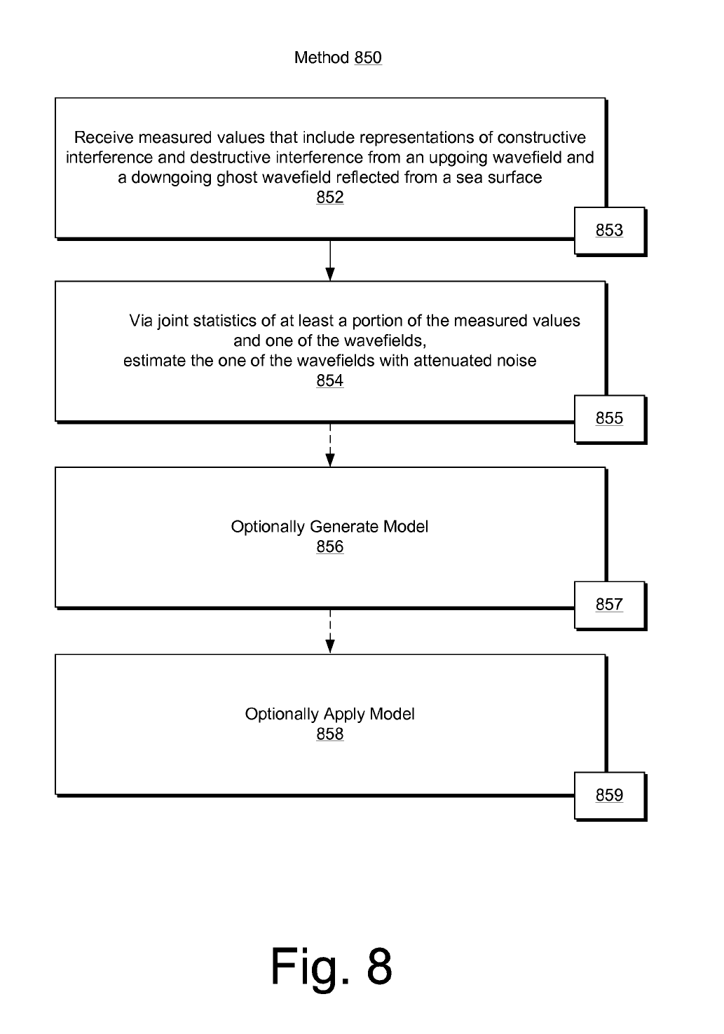

FIG. 8 shows an example of a method 850 that includes a reception block 852 for receiving measured values that include representations of constructive interference and destructive interference from an upgoing wavefield and a downgoing ghost wavefield reflected from a sea surface and an estimation block 854 for, via joint statistics of at least a portion of the measured values and one of the wavefields, estimating the one of the wavefields with attenuated noise. As an example, the estimation block 854 may include joint statistics that include covariance of at least a portion of the measured values and correlation between at least a portion of the measured values and one of the wavefields. As an example, the estimation block 854 may include, via a covariance and correlation formulation for covariance of at least a portion of the measured values and correlation between at least a portion of the measured values and one of the wavefields, estimating the one of the wavefields with attenuated noise. As an example, in the method 850, noise and signals represented by measured values may be assumed to be jointly Gaussian. As an example, a method may include an estimation process where, via minimizing error between a true noise-free one of the wavefields and weighted combination of noisy measurements, estimating the one of the wavefields with attenuated noise.

As an example, the method 850 may further include, for example, a generation block 856 for generating a model and, for example, an application block 858 for applying a generated model. As an example, a model may be a ghost mode, for example, where a ghost model may be deterministic or may be estimated from data by minimizing error. As an example, a method can include generating a ghost model adaptively from data, for example, a ghost model may be generated adaptively from data using joint statistics (e.g., in a manner akin to equation (38)). As an example, a ghost model can be obtained deterministically, for example, by using assumed parameters (e.g., depth and reflection coefficient) in a manner akin to equation (5).

The method 850 may be associated with various computer-readable media (CRM) blocks or modules 853, 855, 857 and 859. Such blocks or modules may include instructions suitable for execution by one or more processors (or processor cores) to instruct a computing device or system to perform one or more actions. As an example, a single medium may be configured with instructions to allow for, at least in part, performance of various actions of the method 850. As an example, a computer-readable medium (CRM) may be a computer-readable storage medium (e.g., a non-transitory medium, one that is not a carrier wave).

As an example, an estimation block may include estimating an upgoing wavefield. As an example, an estimation block may include estimating a downgoing wavefield. As an example, an estimation block may estimate a wavefield, for example, based on at least in part on an a priori formulation that accounts for at least a portion of noise, which may be via a statistical approach to noise. As an example, a method may perform an estimation in a model independent manner.

As an example, a method may include, for at least a portion of measured pressure values and at least a portion of measured particle velocity values, estimating one or more pressure values and one or more particle velocity values for an upgoing wavefield based at least in part on a covariance matrix and a noise covariance matrix that depend on the measured pressure values and measured particle velocity values.

As an example, a method may be applied to pressure data. As an example, a method may be applied to particle velocity data. As an example, a method may be applied to pressure data and to particle velocity data (e.g., as input).

As an example, a method may include minimization, for example, by applying weights where weights may be obtained from recorded data and noise statistics. As an example, noise may be random. As an example, noise may lack phase. As an example, noise may be represented via a statistical technique.

As an example, a method may include denoising data where residual noise may still exist in the data. In such an example, the residual noise may be represented mathematically. As an example, an algorithm may provide for estimating at least one of an upgoing and a downgoing wavefield where the estimated at least one wavefield is noise attenuated. In such an example, noise may be attenuated via one or more mathematical terms that may account for noise, which may be noise in raw data, noise in processed data, residual noise in data, etc. As an example, an algorithm may account for covariance, optionally in the form of a covariance matrix (e.g., or covariance matrices).

As an example, information about noise may optionally be obtained via analysis of a portion of data, for example, that may not include information stemming from an acoustic signal (e.g., firing of an acoustic source).

As an example, an approach may include estimating a ghost operator deterministically (e.g., ODG) using noise statistics, joint deghosting and denoising. As an example, another approach may include generating a ghost operator via a method such as the method 850 of FIG. 8, optionally followed by applying the ghost operator.

As an example, the method 850 may include estimating at least one wavefield in a manner that may denoise and deghost (e.g., without first providing a ghost model). In such an example, a ghost model may be derived (e.g., generated) and then optionally applied, for example, in an ODG manner.

As an example, a statistic may be defined as a quantity that is calculated based on data, which may be measured data, synthetic data, measured and synthetic data, etc. Covariance, as a joint statistic, can provide a measure of the strength of the correlation between two or more sets of random variates. Correlation, as a joint statistic, can provide a strength of a relationship between variates. Statistical correlation is related to covariance and standard deviation. As an example, a Gaussian process can be defined as a stochastic process whose realizations consist of random values associated with points in a range of times or of space such that an individual random variable has a respective normal distribution. For a Gaussian process, a finite linear combination of samples can have a joint Gaussian distribution. As an example, where noise and signals may be assumed to be jointly Gaussian, an estimator may be the optimal estimator for a formulation and may be considered to be the best among linear and nonlinear filters in a minimum mean square error sense.

### Example of Optimal Bayesian Deghosting Technique

As an example, an approach may include applying a joint deghosting and noise attenuation framework to single and/or multiple measurements. For example, as an approach may be applied to multi-measurement pressure data where it may be implemented for over-under multi-measurement, over/sparse under streamers etc.

As an example, of a model-independent approach (e.g., MIA), one may per a method such as the method 850 of FIG. 8 estimate an upgoing wavefield. For example, consider estimating an upgoing wave using a weighting scheme that weights available measurement and minimizes error in estimating the upgoing wavefield. In such an approach, the error includes the noise and the deghosting errors (e.g., a denoising and deghosting approach).

As an example, a minimum mean square error criterion may be implemented, however, one or more other criteria may be used (e.g., minimizing the L1 norm, maximizing the posterior probability, etc.). In addition, as an example, one or more different constraints may be applied to a weighting scheme. Referring again to equation (35), the minimum mean square error approach may be illustrated as:

$${\hat{U}}_{MI} = {\underline{r}}_{MU}^{H} {R}_{MM}^{- 1} [ \begin{matrix}{P}_{n} \\ {X}_{n} \\ {Y}_{n} \\ {Z}_{n}\end{matrix} ]$$

which is an example of a model independent (MI) approach (e.g., using a MIA) that may cover a case where multisensory measurements are available. In such an example, as long as the multi-measurement information includes complementary information about the ghost operators (e.g., over/under, slanted streamer, etc.), this framework can achieve the deghosting as well as noise attenuation, for example, without a need to explicitly estimate or get a ghost model such as a ghost model: G.

As an example, a model hybrid approach may be taken. For example, if multi-measurement information includes complementary information about a ghost operator, a denoising and deghosting framework may be applied, however, as part of a different approach. For example, rather than deghosting data without explicitly estimating a ghost operator, a framework may estimate a ghost operator explicitly. For example, in the case of pressure and vertical velocity data, a pressure ghost operator can be obtained as:

$${\hat{G}}_{P} = 2 \frac{{R}_{{P}_{n} {P}_{n}} - {σ}_{{n}_{P }}^{2} + {R}_{{P}_{n} {Z}_{n}}}{{R}_{{P}_{n} {P}_{n}} - {σ}_{{n}_{P}}^{2} + {R}_{{P}_{n} {Z}_{n}} + {R}_{{Z}_{n} {P}_{n}} + {R}_{{Z}_{n} {Z}_{n}} - {σ}_{{n}_{Z}}^{2}} . \qquad ( 38 )$$

The foregoing equation can use data to obtain an estimate of a ghost operator. As an example, one or more other ways to estimate a ghost operator from measurements may be implemented. Similarly, for multi-measurement data, one or more other ghost operators may be estimated (e.g., a vertical velocity ghost operator, a different depth ghost operator, etc.)

As an example, a method can include estimating one or more ghost operators using multi-measurement information. In turn, an estimated ghost operator (e.g., or operators) may be used as: (a) an initial estimate that can be refined later using other techniques and/or; (b) an applied estimated ghost operator(s) in one or more existing deghosting techniques such as (ODG, SSD, DPS, etc.); and/or (c) part of a hybrid approach with one or more existing model based techniques. For example, if one or more ghost operators are unknown at one or more frequencies, a framework may be applied that can provide initial estimates of the one or more ghost operators. As an example of DPS (“dephase and sum deghosting algorithm”), see for example, Posthumus, B. J., 1993, Deghosting using a twin streamer configuration: Geophysical Prospecting, 41, 267-286. As an example of using estimated ghost operators in ODG, consider the following formulation:

$${\hat{U}}_{MD} = {\hat{U}}_{MD , m} = \frac{\frac{{\hat{G}}_{P}^{H}}{{σ}_{{n}_{p}}^{2}} {P}_{n} + \frac{{\hat{G}}_{Z}^{H}}{{σ}_{{n}_{z}}^{2}} {Z}_{n}}{\frac{{\vert {\hat{G}}_{p} \vert}^{2}}{{σ}_{{n}_{p}}^{2}} + \frac{{\vert {\hat{G}}_{z} \vert}^{2}}{{σ}_{{n}_{z}}^{2}}} . \qquad ( 39 )$$

which is a model dependent (MD) approach (e.g., consider using a model dependent algorithm, MDA). As an example, an upgoing wave can be estimated using an approach that includes a formulation akin to equation (32), for example, using estimated ghost operators instead.

As an example, in a single measurement approach (e.g., pressure or particle velocity), a framework may be applied to the case where the ghost operator is known or estimated from the data in an adaptive way. In such an example, the framework may contribute in a noise attenuation manner.

As an example, a framework may be configured to generalize one or more existing single sensor deghosting techniques to be able to handle noise. For example, akin to multi-measurement, a method may include estimating the weight that minimizes the error in the upgoing wavefield. As an example, using the minimum mean square error criterion for minimization, equation (34) may provide the upgoing wave as:

$${\hat{U}}_{MD , s} = \frac{{G}_{P}^{H}}{{G}_{P} {G}_{P}^{H} + \frac{{σ}_{{n}_{P}}^{2}}{{R}_{UU}}} {P}_{n} . \qquad ( 40 )$$

which is a single measurement model dependent (MD) approach (e.g., using a MDA). In such an approach, a model may be obtained, for example, deterministically or adaptively.

In the foregoing equation (40), the upgoing wave may be estimated as a function of the ghost operator Gₚ, the estimated noise power σₙ_{ₚ}² and the estimated upgoing signal power (R_{UU}). In excluding the

$$\frac{{σ}_{{n}_{P}}^{2}}{{R}_{UU}}$$

term, the foregoing equation (40) may be akin to an equation for single sensor deghosting. As an example, the ghost operator Gₚ may be known, however, as explained, it may be estimated as well from the data (e.g., for a particular purpose or purposes, which may be frequency related, etc.). As an example, a framework may be applied to attenuate the noise leakage.

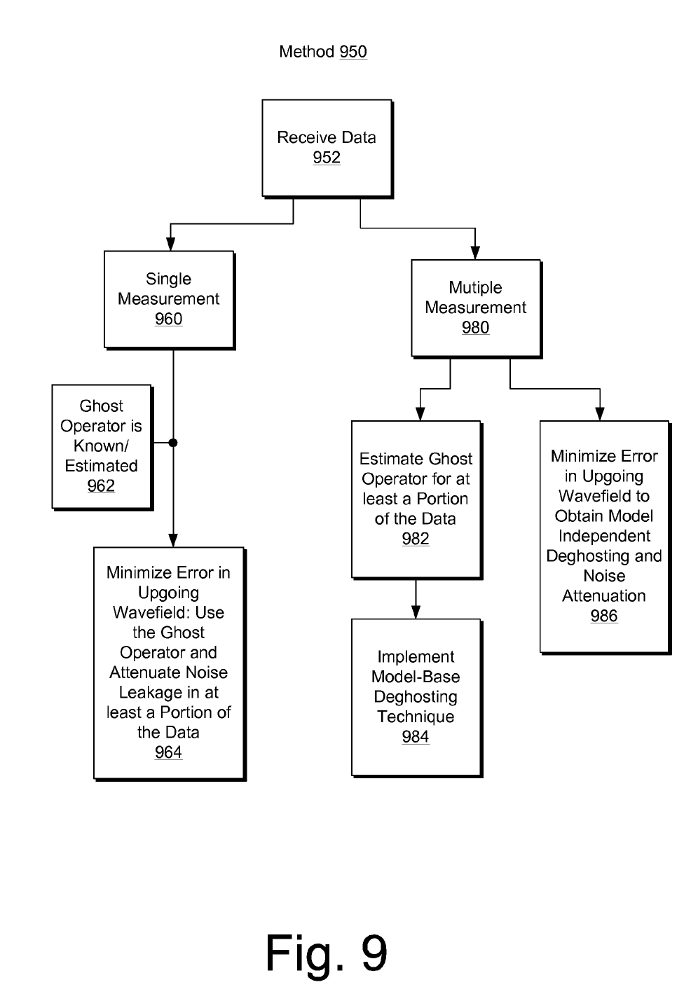

FIG. 9 shows an example of a method 950 that may include a single measurement block 960 (e.g., pressure measurement or particle velocity measurements) and/or a multiple measurement block 980 (e.g., pressure and particle velocity measurements or pressure measured at different depths). As shown, the single measurement block 960 may proceed with a knowable (e.g., estimatable, etc.) ghost operator per a ghost operator block 962. In turn, the method 950 may include an analysis block 964, for example, for minimizing error in an upgoing wavefield using the ghost operator and attenuating noise leakage in at least a portion of the data. As to the multiple measurement block 980, it may include an estimation block 982 and/or an analysis block 986. For example, the estimation block 982 may include estimating a ghost operator for at least a portion of the data (e.g., in a manner that may implement a formulation akin to equation (38)) followed by an implementation block 984 for implementing one or more model-based deghosting techniques (e.g., using the estimated ghost operator or ghost operators in a manner that may implement a formulation akin to equation (39)). As to the analysis block 986, it may include minimizing error in an upgoing wavefield, for example, to obtain model independent deghosting and noise attenuation (e.g., in a manner that may implement a formulation akin to equation (35)).

As an example, a framework may be configured to implement a weighted scheme that can deliver deghosted data using a weighted combination of the deghosted data delivered by an aforementioned MI approach and an aforementioned MD approach, for example, according to a formulation such as:

Û=w_{MD}Û_{MD}+w_{Ml}Û_{Ml}. (41)

where w_{MD}+w_{Ml}=1.

As an example, the weighting framework may be configured to implement a weighting scheme that can deliver deghosted data within a model dependent approach using a weighted combination of single measurement deghosted and multimeasurement deghosted data (see, e.g., equation (39) and (40)), for example, according to a formulation such as:

Û_{MD}=w_{MD,m}Û_{MD,m}+w_{MD,s}Û_{MD,s}. (42)

where w_{MD,m}+w_{MD,s}=1.

The method 950 may be associated with various computer-readable media (CRM) blocks or modules. Such blocks or modules may include instructions suitable for execution by one or more processors (or processor cores) to instruct a computing device or system to perform one or more actions. As an example, a single medium may be configured with instructions to allow for, at least in part, performance of various actions of the method 950. As an example, a computer-readable medium (CRM) may be a computer-readable storage medium (e.g., a non-transitory medium, one that is not a carrier wave).

As an example, a method may include receiving measured values that include representations of constructive interference and destructive interference from an upgoing wavefield and a downgoing ghost wavefield reflected from a sea surface; and estimating at least one of the wavefields with attenuated noise. Such a method may further include, as an example, generating a ghost model (e.g., a ghost operator, etc.) and, optionally, implementing the ghost model (e.g., to process data).

As an example, a method may include estimating at least one of wavefield as a deghosted and noise attenuated wavefield. For example, such estimating may estimate at least an upgoing wavefield as a deghosted and noise attenuated wavefield.

As an example, a system can include a processor; memory accessible by the processor; one or more modules stored in the memory and that include processor-executable instructions to instruct the system to: receive measured values that include representations of constructive interference and destructive interference from an upgoing wavefield and a downgoing ghost wavefield reflected from a sea surface; and estimate at least one of the wavefields with attenuated noise. As an example, such a system may include one or more modules that include processor-executable instructions to instruct the system to generate a ghost model and, for example, to instruct the system to implement the generated ghost model, which may be, for example, a ghost operator.

As an example, a method can include receiving measured values that include representations of constructive interference and destructive interference from an upgoing wavefield and a downgoing ghost wavefield reflected from a sea surface; and via joint statistics of at least a portion of the measured values and one of the wavefields, estimating the one of the wavefields with attenuated noise. In such a method, noise and signals represented by the measured values may be assumed to be jointly Gaussian. As an example, a method may include joint statistics such as, for example, covariance of at least a portion of measured values and correlation between at least a portion of the measured values and one of an upgoing or downgoing wavefield. As an example, estimating may estimate an upgoing wavefield.

As an example, a method can include ghost model independent estimating of the one of an upgoing or a downgoing wavefield with attenuated noise. In such an example, the method may include ghost model dependent estimating of at least one of the wavefields with attenuated noise. Such a method may further include combining wavefields estimated via the ghost model independent estimating and via the ghost model dependent estimating.

As an example, a method may include determining statistics of measurement noise and applying the statistics to attenuate noise.

As an example, a method may include generating a ghost model and, for example, implementing the ghost model.

As an example, measured values may include pressure values, particle velocity values or pressure values and particle velocity values.

As an example, a method can include estimating that estimates one of an upgoing or a downgoing wavefield as a deghosted and noise attenuated wavefield.

As an example, measured values can include seismic data acquired via a seismic survey.

As an example, a system can include a processor; memory accessible by the processor; one or more modules stored in the memory and that include processor-executable instructions to instruct the system to: receive measured values that include representations of constructive interference and destructive interference from an upgoing wavefield and a downgoing ghost wavefield reflected from a sea surface; and via joint statistics of at least a portion of the measured values and one of the wavefields, estimate the one of the wavefields with attenuated noise. In such an example, the one or more modules can include processor-executable instructions to instruct the system to generate a ghost model and, for example, instructions to instruct the system to implement the generated ghost model. As an example, a ghost model can include or be a ghost operator.

As an example, one or more computer-readable storage media can include computer-executable instructions to instruct a system to: receive single measurement data; and minimize error in an upgoing wavefield at least in part via a ghost operator where the minimization of error attenuates noise leakage in at least a portion of the single measurement data. As an example, one or more computer-readable storage media may include computer-executable instructions to instruct a system to estimate a ghost operator.

As an example, a method can include receiving seismic data from multi-sensor measurements, estimating a noise covariance matrix in the measurements, determining correlations between measurements and determining an upgoing wavefield by minimizing the mean square error as a function of the correlations and noise statistics. As an example, one or more computer-readable media may include computer-executable instructions that can instruct a system to perform one or more actions of such a method. As an example, a system may include memory that can store such instructions.

As an example, a model independent deghosting technique may include utilizing the noise second order statistics in pressure and vertical velocity measurements to combine them optimally and estimate the upgoing wavefield in the minimum mean square error sense. As an example, such an approach may be implemented to optimize bandwidth and/or signal-to-noise ratio. As an example, as may be demonstrated by an FK analysis, such an approach may perform well in areas where noise spectra tend to be high.

As an example, one or more functional modules may be implemented with one or more information processing apparatus such as general purpose processors or application specific chips, such as ASICs, FPGAs, PLDs, or other appropriate devices.

While certain implementations have been disclosed in the context of seismic data collection and processing, one or more of the methods, techniques, and computing systems disclosed herein may optionally be applied in another field and context, for example, where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

In some embodiments, the multi-dimensional region of interest is selected from the group consisting of a subterranean region, human tissue, plant tissue, animal tissue, solid volumes, substantially solid volumes, volumes of liquid, volumes of gas, volumes of plasma and volumes of space near and/or outside the atmosphere of a planet, asteroid, comet, moon or other body.

In some embodiments, the multi-dimensional region of interest includes one or more volume types selected from the group consisting of a subterranean region, human tissue, plant tissue, animal tissue, solid volumes, substantially solid volumes, volumes of liquid, volumes of air, volumes of plasma, and volumes of space near and/or or outside the atmosphere of a planet, asteroid, comet, moon, or other body.

As an example, a system may include one or more modules, which may be provided to analyze data, control a process, perform a task, perform a workstep, perform a workflow, etc.

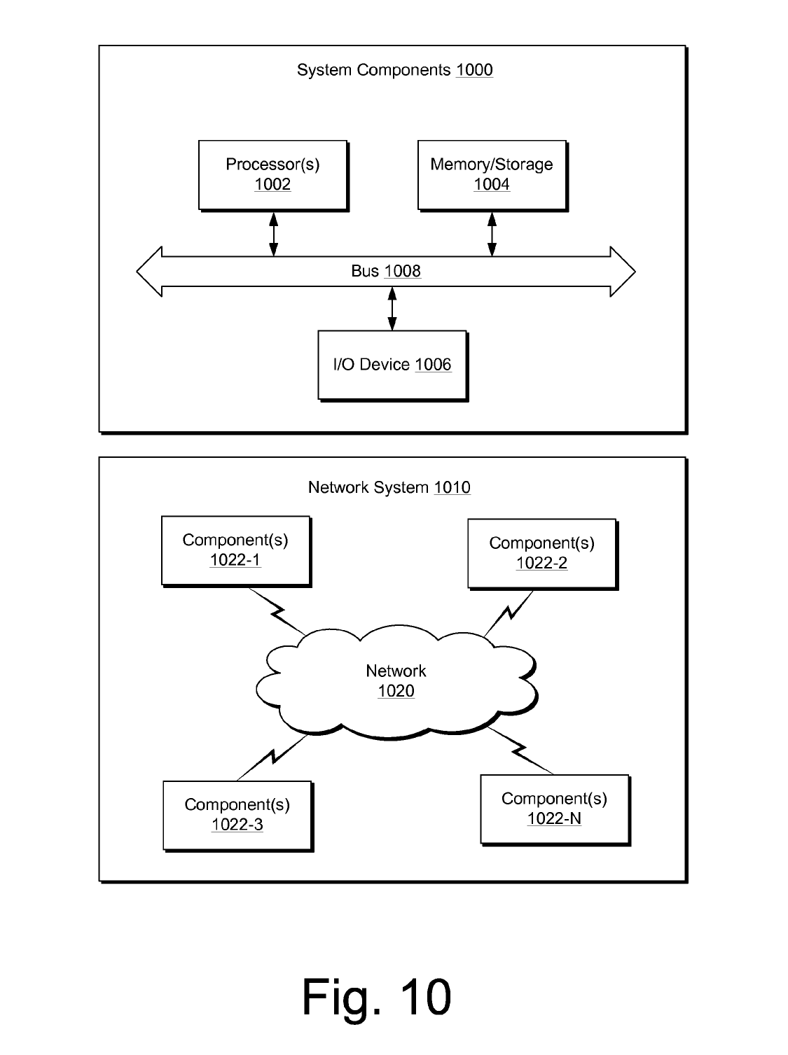

FIG. 10 shows components of an example of a computing system 1000 and an example of a networked system 1010. The system 1000 includes one or more processors 1002, memory and/or storage components 1004, one or more input and/or output devices 1006 and a bus 1008. In an example embodiment, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more attributes (e.g., as part of a method). A user may view output from and interact with a process via an I/O device (e.g., the device 1006). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1010. The network system 1010 includes components 1022-1, 1022-2, 1022-3, . . . 1022-N. For example, the components 1022-1 may include the processor(s) 1002 while the component(s) 1022-3 may include memory accessible by the processor(s) 1002. Further, the component(s) 1002-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving measured values that comprise representations of constructive interference and destructive interference from an upgoing wavefield and a downgoing ghost wavefield reflected from a sea surface; and
via joint statistics of at least a portion of the measured values and one of the wavefields, estimating the one of the wavefields with attenuated noise.

2. The method of claim 1 wherein noise and signals represented by the measured values are assumed to be jointly Gaussian.

3. The method of claim 1 wherein the joint statistics comprise covariance of at least a portion of the measured values and correlation between at least a portion of the measured values and one of the wavefields.

4. The method of claim 1 wherein the estimating comprises ghost model independent estimating of the one of the wavefields with attenuated noise.

5. The method of claim 4 further comprising ghost model dependent estimating of at least one of the wavefields with attenuated noise.

6. The method of claim 5 further comprising combining wavefields estimated via the ghost model independent estimating and via the ghost model dependent estimating.

7. The method of claim 1 further comprising determining statistics of measurement noise and applying the statistics to attenuate noise.

8. The method of claim 1 further comprising generating a ghost model.

9. The method of claim 8 further comprising implementing the ghost model.

10. The method of claim 1 wherein the measured values comprise pressure values.

11. The method of claim 1 wherein the measured values comprise particle velocity values.

12. The method of claim 1 wherein the measured values comprise pressure values and comprise particle velocity values.

13. The method of claim 1 wherein the estimating estimates the one of the wavefields as a deghosted and noise attenuated wavefield.

14. The method of claim 1 wherein the measured values comprise seismic data acquired via a seismic survey.

15. A system comprising:
a processor;
memory accessible by the processor;
one or more modules stored in the memory and that comprise processor-executable instructions to instruct the system to:
receive measured values that comprise representations of constructive interference and destructive interference from an upgoing wavefield and a downgoing ghost wavefield reflected from a sea surface; and
via joint statistics of at least a portion of the measured values and one of the wavefields, estimate the one of the wavefields with attenuated noise.

16. The system of claim 15 wherein the one or more modules comprise processor-executable instructions to instruct the system to generate a ghost model.

17. The system of claim 16 wherein the one or more modules comprise processor-executable instructions to instruct the system to implement the generated ghost model.

18. The method of claim 16 wherein the ghost model comprises a ghost operator.

19. One or more computer-readable storage media comprising computer-executable instructions to instruct a system to:
receive single measurement data; and
minimize error in an upgoing wavefield at least in part via a ghost operator wherein the minimization of error attenuates noise leakage in at least a portion of the single measurement data.

20. The one or more computer-readable storage media of claim 19 comprising computer-executable instructions to instruct a system to estimate the ghost operator.
